(19) United States
(12) Patent Application Publication
(10) Pub. No.: US 2020/0375271 A1
(43) Pub. Date: Dec. 3, 2020

(54) GARMENTS WITH CONFIGURABLE VISUAL APPEARANCES AND SYSTEMS, METHODS AND ARTICLES TO AUTOMATICALLY CONFIGURE SAME

(71) Applicant: ZUME, INC., Camarillo, CA (US)

(72) Inventor: Joshua Gouled Goldberg, Mountain View, CA (US)

(73) Assignee: ZUME, INC., Camarillo, CA (US)

(21) Appl. No.: 16/971,615

(22) PCT Filed: Jun. 14, 2018
(86) PCT No.: PCT/US2018/037548

§ 371 Date: Aug. 20, 2020

Related U.S. Application Data
(60) Provisional application No. 62/633,457, filed on Feb. 21, 2018.

(51) Int. Cl. A41D 1/00; A42B 1/24; G09G 5/22; G09G 3/34; G09G 3/20; H04W 4/021; H04B 1/16; H01Q 1/22; G06Q 10/08; G06Q 30/02; G06K 7/10

(52) U.S. Cl. CPC A41D 1/002; A42B 1/242; G09G 5/22; G09G 3/3453; G09G 3/2003; H04W 4/021; G09G 2370/16; H01Q 1/2208; G06Q 10/0834; G06Q 30/0277; G06K 7/10297; G09G 2380/02; H04B 1/16

(57) ABSTRACT

Garments may adjust appearance based on various input. For example, an appearance (e.g., color scheme, logo, name, branding, insignia, graphic, and, or text) of a garment, for example a uniform or portion(s) thereof may change based on various conditions or contexts. Appearance may be responsive to type of item being delivered or vended or service to be performed. Appearance may be updated in response to detecting an item in proximity, a vehicle in proximity, proximity to a location or geo-fenced area, a seller of an item or service, a buyer of an item or service, a courier service, etc. The appearance may be updated autonomously.

### TECHNICAL FIELD

This description generally relates to garments, for example uniforms, worn by individuals, for example delivery persons and, or, service providers.

### BACKGROUND

### Description of the Related Art

Garments take a large variety of forms, for example shirts, vests, jackets, vests, hats, pants or trousers. Many companies or businesses require employees or contractors to wear a uniform during work hours. Uniforms typically vary widely in composition and appearance. For example, a uniform may simply consist of a shirt that bears a logo, name or other graphic or text associated with a given business. Likewise, a uniform may consist of a hat that bears a logo, name or other graphic or text associated with a given business. In other instances, uniforms may be more elaborate, comprising multiple garments or pieces of clothing, with a defined color scheme, logo, name, insignia, graphic or text associated with a business.

One benefit of a uniform, even a simple single garment uniform is to identify the person wearing such as a representative of the associated business. The uniform may additionally serve as advertisement for the business.

### BRIEF SUMMARY

Historically, uniforms have been static. That is any given garment had a fixed color scheme and fixed logo, name, branding, insignia, graphic or text. Most businesses maintain a single uniform over an extended period of time, typically over several years. Changing uniforms have traditionally required the individuals to replace one or more garments with other garments. While most businesses maintain a uniform over a relatively long period of time, some business may mix uniforms up. For example, a business may require employees to change between different uniforms for each day of the week.

It may be advantageous to provide garments which have the ability to update, modify or change an outward appearance without requiring an individual to change clothing. For example, it may be advantageous to provide garments which have the ability to update, modify or change an outward appearance between successive deliveries of product, between successive service calls, or between vending a first product and successively vending a second product. It may be advantageous to provide garments which have the ability to update, modify or change an outward appearance in real-time or almost real-time. Further it may be advantageous to provide a system in which garments automatically change appearance in response to certain stimulus or conditions or events. For example, it may be advantageous to provide garments which have the ability to update, modify or change an outward appearance in response to an item or type of item being delivered or vended, or a service or type of service to be rendered. For example, it may be advantageous to provide garments which have the ability to update, modify or change an outward appearance in response to being in proximity of an item being delivered or vended, or location, for instance a destination at which a product will be delivered, vended or a service rendered.

It may be particularly advantageous to provide garments which have the ability to update, modify or change an outward appearance for those working multiple jobs (i.e., the “gig economy”). Such may allow an individual to perform a first job at a first time wearing a garment or uniform that is visually associated (e.g., bearing a first color scheme, logo, name, branding, insignia, graphic or text) with the first job, and perform a second job at a second time, for instance immediately following completion of the first job, wearing a garment or uniform that is visually associated with the second job, all without requiring the individual to change garments. Such can be repeated, successively switching between two or more jobs and two or more uniforms without needing to physically change clothing.

It may be particularly advantageous to provide garments which have the ability to update, modify or change an outward appearance for a business that has multiple brands or which desires to keep its advertising fresh. Such may allow a business to have a garment worn by an individual delivering or vending a first item or rendering a first service at a first time present a first color scheme, logo, name, branding, insignia, graphic or text at the first time. The business can then have the same garment worn by the individual delivering or vending a second item or rendering a second service at a second time present a second color scheme, logo, name, branding, insignia, graphic or text at the second time. Such can be repeated, successively switching between two or more deliveries or service calls without needing to physically change clothing.

A garment may be summarized as including a fabric comprising at least a first plurality of addressable pixels, the addressable pixels each operable to change a respective optical appearance thereof; and a control circuit communicatively coupled to control the respective optical appearance of the addressable pixels to form at least a first identifying indicia at a first time and to form at least a second identifying indicia at a second time, the second identifying indicia different from the first identifying indicia. The fabric may have an outward facing surface that is visible when the garment is worn, and the outward facing surface may be entirely populated by the addressable pixels. The fabric may have an outward facing surface that is visible when the garment is worn, and the outward facing surface may be only partially populated by the addressable pixels. The fabric may include at least a second plurality of addressable pixels. The fabric may have an outward facing surface that is visible when the garment is worn, and a first portion of the outward facing surface may be populated by the addressable pixels of the first plurality of pixels and a second portion of the outward facing surface may be populated by the addressable pixels of the second plurality of pixels, the second portion space from the first portion at least when the garment is worn.

The garment may further include at least one receiver communicatively coupled to the control circuit, the at least one receiver operable to provide signals to the control circuit in response to receipt of signals from an external source that is external to the garment.

The at least one receiver may be a radio, and may further include at least one antenna communicatively coupled to the radio. Such can provide for various forms of communications, for example cellular network communication, WI-FI network communication, BLUETOOTH® communication, Global Positioning System (GPS) communications, other global positioning systems (e.g., GNSS, GLOSNASS) communications, communications from remote sources, from beacons, from wireless transponders associated with items or packaging of item, communications with vehicles, etc. The at least one receiver may be a radio frequency identification (RFID) interrogator. The control circuit may be responsive to signals that indicate a present location of the garment. The control circuit may be responsive to signals that indicate a present location of the garment relative to a defined destination. The control circuit may be responsive to signals that indicate that the garment is in a defined spatial relationship to a geo-fenced location. The control circuit may be responsive to signals that indicate that the garment is in a defined spatial relationship to a geo-fenced destination location. The control circuit may be responsive to signals that indicate an item is in a defined proximity of the garment. The control circuit may be responsive to signals that indicate a type of an item to be delivered. The control circuit may be responsive to signals that indicate an item to be delivered is in a defined spatial relationship to a geo-fenced location. The control circuit may be responsive to signals that indicate a seller of an item to be delivered. The control circuit may be responsive to signals that indicate a courier service. The control circuit may be responsive to signals that indicate a type of a service to be rendered. The control circuit may be responsive to signals that indicate a business that offers a service to be rendered. The control circuit may be responsive to signals that indicate a vehicle to be used in delivering at least one of items or services. The garment may be one of a shirt, a jacket, a vest, overalls, or a hat. The garment may be at least a portion of a uniform. The fabric may include electronic paper.

The first identifying indicia may be at least one of a name or a logo of a first company or a first brand, and the second identifying indicia may be at least one of a name or a logo of a second company or a second brand, different than the first company or the first brand. The first identifying indicia may be a first color scheme associated with a first company or a first brand, and the second identifying indicia may be a second color scheme associated with a second company or a second brand, different than the first company or the first brand. The first identifying indicia may be a first advertisement, and the second identifying indicia may be a second advertisement, the second advertisement different than the first advertisement.

A method of operation in a garment may be summarized as including a fabric including at least a first plurality of addressable pixels and a control circuit communicatively coupled to control a respective optical appearance of the addressable pixels, in response to a first signal, the control circuit causing the respective optical appearance of the addressable pixels to form at least a first identifying indicia at a first time; and in response to a first signal, the control circuit causing the respective optical appearance of the addressable pixels to form at least a second identifying indicia at a second time, the second identifying indicia different from the first identifying indicia. Causing the respective optical appearance of the addressable pixels to form at least a first identifying indicia at a first time may include causing the first identifying indicia to be displayed in a first area of the garment at the first time, and causing the respective optical appearance of the addressable pixels to form at least a second identifying indicia at a second time includes causing the second identifying indicia to be displayed in a second area of the garment at the second time, the second area different than the first area. Causing the respective optical appearance of the addressable pixels to form at least a first identifying indicia at a first time may include causing the first identifying indicia to be displayed in a first area of the garment at the first time, and causing the respective optical appearance of the addressable pixels to form at least a second identifying indicia at a second time includes causing the second identifying indicia to be displayed in the first area of the garment at the second time.

The garment including at least one receiver communicatively coupled to the control circuit may further include providing signals by the at least one receiver to the control circuit in response to receipt of signals from an external source that is external to the garment.

The at least one receiver may be a radio and may further include receiving signals by the radio via at least one antenna communicatively coupled to the radio.

The at least one receiver may be a radio frequency identification (RFID) interrogator and may further include interrogating at least one RFID transponder by the RFID interrogator.

The at least one receiver may be a radio frequency identification (RFID) interrogator and may further include interrogating at least one RFID transponder by the RFID interrogator, the at least one RFID transponder physically associated with an item to be delivered.

The method may further include receiving signals that indicate a present location of the garment, and wherein the causing the respective optical appearance of the addressable pixels to form at least a first identifying indicia at a first time and at least a second identifying indicia at a second time is in response to the signals that indicate the present location of the garment.

The method may further include receiving signals that indicate a present location of the garment relative to a defined destination, and wherein the causing the respective optical appearance of the addressable pixels to form at least a first identifying indicia at a first time and at least a second identifying indicia at a second time is in response to the signals that indicate the present location of the garment relative to the defined destination.

The method may further include receiving signals that indicate that the garment is a defined spatial relationship to a geo-fenced location, and wherein the causing the respective optical appearance of the addressable pixels to form at least a first identifying indicia at a first time and at least a second identifying indicia at a second time is in response to the signals that indicate the garment is in the defined spatial relationship to a geo-fenced location.

The method may further include receiving signals that indicate that the garment is a defined spatial relationship to a geo-fenced destination location, and wherein the causing the respective optical appearance of the addressable pixels to form at least a first identifying indicia at a first time and at least a second identifying indicia at a second time is in response to the signals that indicate the garment is in the defined spatial relationship to the geo-fenced destination location.

The method may further include receiving signals that indicate an item is in a defined proximity of the garment, and wherein the causing the respective optical appearance of the addressable pixels to form at least a first identifying indicia at a first time and at least a second identifying indicia at a second time is in response to the signals that indicate the item is in the defined proximity of the garment.

The method may further include receiving signals that indicate a type of an item to be delivered, and wherein the causing the respective optical appearance of the addressable pixels to form at least a first identifying indicia at a first time and at least a second identifying indicia at a second time is in response to the signals that indicate the type of an item to be delivered.

The method may further include receiving signals that indicate an item to be delivered is in a defined spatial relationship to a geo-fenced location, and wherein the causing the respective optical appearance of the addressable pixels to form at least a first identifying indicia at a first time and at least a second identifying indicia at a second time is in response to the signals that indicate the item to be delivered is in the defined spatial relationship to the geo-fenced location.

The method may further include receiving signals that indicate a seller of an item to be delivered, and wherein the causing the respective optical appearance of the addressable pixels to form at least a first identifying indicia at a first time and at least a second identifying indicia at a second time is in response to the signals that indicate the seller of the item to be delivered.

The method may further include receiving signals that indicate a courier service that will deliver an item, and wherein the causing the respective optical appearance of the addressable pixels to form at least a first identifying indicia at a first time and at least a second identifying indicia at a second time is in response to the signals that indicate the courier service that will deliver the item.

The method may further include receiving signals that indicate a type of a service to be rendered, and wherein the causing the respective optical appearance of the addressable pixels to form at least a first identifying indicia at a first time and at least a second identifying indicia at a second time is in response to the signals that indicate the type of services to be rendered.

The method may further include receiving signals that indicate a business that offers a service to be rendered, and wherein the causing the respective optical appearance of the addressable pixels to form at least a first identifying indicia at a first time and at least a second identifying indicia at a second time is in response to the signals that indicate the business that offers the service to be rendered.

The method may further include receiving signals that indicate a vehicle to be used in delivering at least one of items or services, and wherein the causing the respective optical appearance of the addressable pixels to form at least a first identifying indicia at a first time and at least a second identifying indicia at a second time is in response to the signals that indicate the vehicle to be used in delivering at least one of items or services.

The garment may be one of a shirt, a jacket, a vest, overalls, a hat, or a portion of a uniform, the fabric may include electronic paper, and causing the respective optical appearance of the addressable pixels to form at least a first identifying indicia at a first time and at least a second identifying indicia at a second time may include selectively controlling the electronic paper. Causing the respective optical appearance of the addressable pixels to form at least a first identifying indicia at a first time and at least a second identifying indicia at a second time may include causing presentation of at least one of a name or a logo of a first company or a first brand at the first time, and causing presentation of at least one of a name or a logo of a second company or a second brand at the second time, the second company or the second brand different than the first company or the first brand. Causing the respective optical appearance of the addressable pixels to form at least a first identifying indicia at a first time and at least a second identifying indicia at a second time may include causing presentation of a first color scheme associated with a first company or a first brand at the first time, and causing presentation of a second color scheme associated with a second company or a second brand at the second time, the second company or the second brand different than the first company or the first brand. Causing the respective optical appearance of the addressable pixels to form at least a first identifying indicia at a first time and at least a second identifying indicia at a second time may include causing presentation of a first advertisement at the first time, and causing presentation of a second advertisement at the second time, the second advertisement different than the first advertisement.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1A is a schematic diagram of an appearance configuration device including a portion of a garment that comprises a plurality of addressable pixels and a control subsystem operatively coupled to control a visual appearance produced by the addressable pixels to, according to at least one illustrated implementation.

FIG. 1B is a schematic diagram of an appearance configuration device including a plurality of addressable pixels selectively detachably attachable to at least a portion of a garment, a control subsystem selectively detachably attachable to at least a portion of a garment, and at least one communications channel selectively detachably coupleable to at least one of the plurality of addressable pixels or the control subsystem to operatively couple the control subsystem to control a visual appearance produced by the addressable pixels to, according to at least one illustrated implementation.

FIG. 1C is a schematic diagram of an appearance configuration device including a plurality of addressable pixels selectively detachably attached to at least a portion of a garment, a control subsystem selectively detachably attached to at least a portion of a garment, and at least one communications channel selectively detachably coupleable to at least one of the plurality of addressable pixels or the control subsystem to operatively couple the control subsystem to control a visual appearance produced by the addressable pixels to, according to at least one illustrated implementation.

FIG. 2A is an isometric view of a garment at a first time, the garment taking the form of a hat comprising an appearance configuration device, the device presenting a first optical appearance (e.g., a first color scheme, logo, name, branding, insignia, graphic, and, or text) at the first time, for instance in respect to a condition or stimulus or input, according to at least one illustrated implementation.

FIG. 2B is an isometric view of the garment of FIG. 2A at a second time, the appearance configuration device presenting a second optical appearance (e.g., a second color scheme, logo, name, branding, insignia, graphic, and, or text) at the second time, for instance in respect to a condition or stimulus or input, according to at least one illustrated implementation.

FIG. 3A is an isometric view of a garment at a first time, the garment taking the form of a shirt comprising an appearance configuration device, the device presenting a first optical appearance (e.g., a first color scheme, logo, name, branding, insignia, graphic, and, or text) at the first time, for instance in respect to a condition or stimulus or input, according to at least one illustrated implementation.

FIG. 3B is an isometric view of the garment of FIG. 3A at a second time, the appearance configuration device presenting a second optical appearance (e.g., a second color scheme, logo, name, branding, insignia, graphic, and, or text) at the second time, for instance in respect to a condition or stimulus or input, according to at least one illustrated implementation.

FIG. 4A is an isometric view of a garment at a first time, the garment taking the form of a vest comprising an appearance configuration device, the device presenting a first optical appearance (e.g., a first color scheme, logo, name, branding, insignia, graphic, and, or text) at the first time, for instance in respect to a condition or stimulus or input, according to at least one illustrated implementation.

FIG. 4B is an isometric view of the garment of FIG. 4A at a second time, the appearance configuration device presenting a second optical appearance (e.g., a second color scheme, logo, name, branding, insignia, graphic, and, or text) at the second time, for instance in respect to a condition or stimulus or input, according to at least one illustrated implementation.

FIG. 5A is an isometric view of a garment at a first time, the garment taking the form of a jacket comprising an appearance configuration device, the device presenting a first optical appearance (e.g., a first color scheme, logo, name, branding, insignia, graphic, and, or text) at the first time, for instance in respect to a condition or stimulus or input, according to at least one illustrated implementation.

FIG. 5B is an isometric view of the garment of FIG. 5A at a second time, the appearance configuration device presenting a second optical appearance (e.g., a second color scheme, logo, name, branding, insignia, graphic, and, or text) at the second time, for instance in respect to a condition or stimulus or input, according to at least one illustrated implementation.

FIG. 6A is an isometric view of a garment at a first time, the garment taking the form of a pants or slacks comprising an appearance configuration device, the device presenting a first optical appearance (e.g., a first color scheme, logo, name, branding, insignia, graphic, and, or text) at the first time, for instance in respect to a condition or stimulus or input, according to at least one illustrated implementation.

FIG. 6B is an isometric view of the garment of FIG. 6A at a second time, the appearance configuration device presenting a second optical appearance (e.g., a second color scheme, logo, name, branding, insignia, graphic, and, or text) at the second time, for instance in respect to a condition or stimulus or input, according to at least one illustrated implementation.

FIG. 7 is an environmental view showing an environment in which one or more appearance configuration devices according to FIGS. 1A-1C may be employed, including one or more hub systems, one or more individuals who delivery or vend items or render services in one or more geographical regions, one or more vehicles used to deliver or vend items or make service calls, one or more destinations, and one or more geo-fenced areas, according to at least one illustrated implementations.

FIG. 8 is a schematic diagram showing an appearance configuration device of a garment communicating with a wireless transponder carried by an item or packaging, according to at least one illustrated implementation

FIG. 9 a schematic diagram showing an environmental in which one or more appearance configuration devices according to FIGS. 1A-1C may be employed, including one or more hub systems, one or more individuals who delivery or vend items or render services in one or more geographical regions, one or more vehicles used to deliver or vend items or make service calls, one or more destinations, and one or more geo-fenced areas, according to at least one illustrated implementations.

FIG. 10 is a logic flow diagram showing a high level method of operation of a device, for instance an appearance configuration device such as described with reference to FIGS. 1A-1C, according to one illustrated implementation.

FIG. 11 is a logic flow diagram showing a low level method of operation of a device, for instance an appearance configuration device such as described with reference to FIGS. 1A-1C, based on a condition, according to one illustrated implementation.

FIG. 12 is a logic flow diagram showing a low level method of operation of a device, for instance an appearance configuration device such as described with reference to FIGS. 1A-1C, based on a condition, according to one illustrated implementation.

FIG. 13 is a logic flow diagram showing a low level method of operation of a device, for instance an appearance configuration device such as described with reference to FIGS. 1A-1C, based on a condition, according to one illustrated implementation.

FIG. 14 is a logic flow diagram showing a low level method of operation of a device, for instance an appearance configuration device such as described with reference to FIGS. 1A-1C, based on a condition, according to one illustrated implementation.

FIG. 15 is a logic flow diagram showing a low level method of operation of a device, for instance an appearance configuration device such as described with reference to FIGS. 1A-1C, based on a condition, according to one illustrated implementation.

FIG. 16 is a logic flow diagram showing a low level method of operation of a device, for instance an appearance configuration device such as described with reference to FIGS. 1A-1C, based on a condition, according to one illustrated implementation.

FIG. 17 is a logic flow diagram showing a low level method of operation of a device, for instance an appearance configuration device such as described with reference to FIGS. 1A-1C, based on a condition, according to one illustrated implementation.

FIG. 18 is a logic flow diagram showing a low level method of operation of a device, for instance an appearance configuration device such as described with reference to FIGS. 1A-1C, based on a condition, according to one illustrated implementation.

FIG. 19 is a logic flow diagram showing a low level method of operation of a device, for instance an appearance configuration device such as described with reference to FIGS. 1A-1C, based on a condition, according to one illustrated implementation.

FIG. 20 is a logic flow diagram showing a low level method of operation of a device, for instance an appearance configuration device such as described with reference to FIGS. 1A-1C, based on a condition, according to one illustrated implementation.

FIG. 21 is a logic flow diagram showing a low level method of operation of a device, for instance an appearance configuration device such as described with reference to FIGS. 1A-1C, based on a condition, according to one illustrated implementation.

FIG. 22 is a logic flow diagram showing a low level method of operation of a device, for instance an appearance configuration device such as described with reference to FIGS. 1A-1C, based on a condition, according to one illustrated implementation.

FIG. 23 is a logic flow diagram showing a low level method of operation of a device, for instance an appearance configuration device such as described with reference to FIGS. 1A-1C, based on a condition, according to one illustrated implementation.

FIG. 24 is a logic flow diagram showing a low level method of operation of a device, for instance an appearance configuration device such as described with reference to FIGS. 1A-1C, based on a condition, according to one illustrated implementation.

FIG. 25 is a logic flow diagram showing a low level method of operation of a device, for instance an appearance configuration device such as described with reference to FIGS. 1A-1C, based on a condition, according to one illustrated implementation.

FIG. 26 is a logic flow diagram showing a low level method of operation of a device, for instance an appearance configuration device such as described with reference to FIGS. 1A-1C, based on a condition, according to one illustrated implementation.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, certain structures associated with garments, display technologies (e.g., electronic paper), wired and wireless communications protocols, wired and wireless transmitters, receivers, transceivers (collectively radios), wireless beacons, wireless transponders, communications ports, position or geolocation determination, and optimized route mapping algorithms have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in this specification and the appended claims the term “wireless” or “wirelessly” refers to the transmission of signals between two or more devices without the use of a physical wired or optical (e.g., optical fiber) path, even though the respective devices themselves may, or may not, include one or more wires or optical fibers. As used in this specification and the appended claims the term “wired” or “wiredly” refers to the transmission of signals between two devices via a physical wired or optical (e.g., optical fiber) path between the devices.

As used herein the terms “item” and “items” refer to any physical object which may be vended, or delivered or transported to another location or destination.

As used herein the terms “food item” and “food product” refer to any item or product intended for human consumption. Although illustrated and described herein in the context of pizza to provide a readily comprehensible and easily understood description of one illustrative embodiment, one of ordinary skill in the culinary arts and food preparation will readily appreciate the broad applicability of the systems, methods, and apparatuses described herein across any number of prepared food items or products, including cooked and uncooked food items or products, and ingredients or components of food items and products.

As used herein the terms “robot” or “robotic” refer to any device, system, or combination of systems and devices that performs desired operations on times, including the transportation of times. Robots may optionally include one or more appendages, typically with an end of arm tool or end effector, where the appendage(s) is(are) selectively moveable to perform work or an operation useful in the preparation an item (e.g., a food item), packaging of an item, or transport of an item. Robot may be autonomously controlled, for instance based at least in part on information from one or more sensors (e.g., optical sensors used with machine-vision algorithms, position encoders, temperature sensors, moisture or humidity sensors). Alternatively, one or more robots can be remotely controlled by a human operator. Alternatively, one or more robots can be partially remotely controlled by a human operator and partially autonomously controlled (i.e. semi-autonomous).

As used herein the term “vehicle” refers to any car, truck, van, or other vehicle useful in cooking and heating a food item for distribution to a customer. The size and shape of the vehicle may depend in part on licensing requirements of the locality in which the vehicle is intended to operate. In some instances, the size and shape of the vehicle may depend on the street layout and the surrounding environment of the locality in which the vehicle is intended to operate. For example, small, tight city streets may require a vehicle that is comparatively shorter and/or narrower than a vehicle that can safely and conveniently navigate larger, suburban thoroughfares. One or more vehicles may be autonomous vehicles, self-operated based on information received via a number of sensors or transducers (e.g., cameras, radars). One or more vehicles may be non-autonomous vehicles, controlled by human input provided by a human located in the vehicle or remotely located from the vehicle. One or more vehicles may be semi-autonomous vehicles, partially autonomously controlled and partially controlled by a combination of human input provided by a human located in the vehicle or remotely located from the vehicle.

The headings and Abstract of the Disclosure provided herein are for convenience only and do not interpret the scope or meaning of the embodiments.

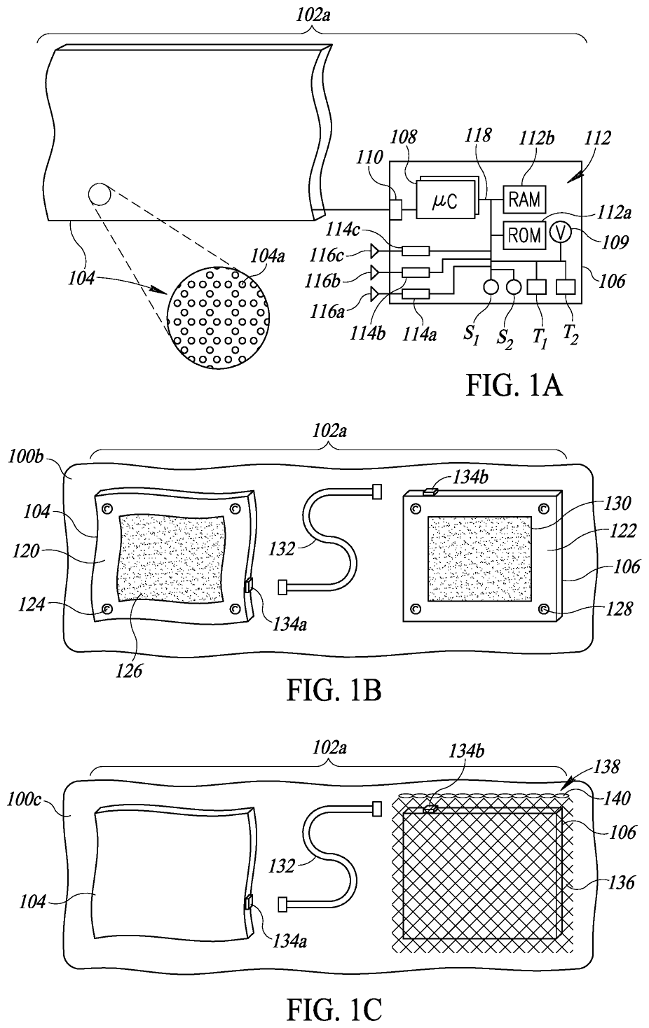

FIG. 1A shows a garment 100a that comprises an appearance configuration device 102a, according to at least one illustrated implementation.

The appearance configuration device 102a comprises a plurality of addressable pixels 104 and a control subsystem 106 operatively coupled to control a visual appearance produced by the addressable pixels 104. The plurality of addressable pixels 104 may take the form of electronic paper or a flexible organic light emitting diode (OLED) material. The plurality of addressable pixels 104 may form an integral portion of the garment 100a, as illustrated in FIG. 1A. For example, the plurality of addressable pixels 104 and the garment 100a may constitute a single unitary structure. Also for example, the plurality of addressable pixels 104 may be permanently attached (e.g., adhered, sewn) to a fabric comprising a layer (e.g., foundation) of garment 100a. Alternatively, as discussed in reference to FIGS. 1B and 1C, the plurality of addressable pixels 104 may be removably or detachably coupled to a fabric layer of the garment 100a.

The plurality of addressable pixels 104 may cover all or a substantial (i.e., equal to or greater than 50%) of a visible surface area of the garment 100a. That is the plurality of addressable pixels 104a may cover all or a substantial surface area of the garment 100a that is typically visible by others when the garment 100a is worn by an individual. Alternatively, the plurality of addressable pixels 104 may cover one or more sub-portions or sub-regions areas of the visible surface area of the garment 100a.

As illustrated in the magnified view, the plurality of addressable pixels 104 may each be individually addressable pixels 104a (only one called out to avoid clutter). Each of the addressable pixels 104 may be operable to take on one of at least to distinct visual appearances. For example, where the plurality of addressable pixels 104 take the form of electronic paper, each addressable pixels 104 is typically operable to switch between two distinct optical appearances (e.g., black, white). For example, where the plurality of addressable pixels 104 take the form of OLEDs, each addressable pixels 104 is typically operable to switch between two distinct optical appearances (e.g., black, red; black, blue; black, green). Electronic paper may advantageously consume less power than, for example OLEDs. OLEDs may advantageously produce a wider variation in appearance, for example rendering a wider range of colors than electronic paper. Some implementations may employ a simple two binary scheme (e.g., black, white) and render a color scheme, logo, name, branding, insignia, graphic, and, or text using only those two colors. Such implementations may advantageously employ groups of pixels or drive levels to render grey scale. Some implementations may employ a three color scheme (e.g., red, blue, green) and render a color scheme, logo, name, branding, insignia, graphic, and, or text using those base colors to render a large variety of colors.

The control subsystem 106 may include one or more processors 108, for example one or more of: one or more micro-controllers, microprocessors, central processing units (CPUs), digital signal processors (DSPs), graphical processing units (GPUs), application specific integrated circuits (ASICs), field programmable gate arrays (FPGAs), programmable logic controllers (PLCs) or other logic circuits. Non-limiting examples of commercially available processors include, but are not limited to, an Atom, Pentium, or 80×86 architecture microprocessor as offered by Intel Corporation, a Snapdragon processor as offered by Qualcomm, Inc., a PowerPC microprocessor as offered by IBM, a Sparc microprocessor as offered by Sun Microsystems, Inc., a PA-RISC series microprocessor as offered by Hewlett-Packard Company, an A6 or A8 series processor as offered by Apple Inc., or a 68xxx series microprocessor as offered by Motorola Corporation. The one or more processors 108 are operable to execute logic, and control operation accordingly. For example, the one or more processors 108 can execute one or more set of processor-executable instructions and, or data. While the control subsystem 106 and processor 108 will at times be referred to in the singular herein, this is not intended to limit the embodiments to a single subsystem or single processor, since in certain embodiments, there will be more than one subsystem, more than one processor, or other networked computers involved.

The control subsystem 106 may include one or more drive circuits 110, communicatively coupled to control the appearance of the plurality of addressable pixels 104, for example by changing a polarity of a voltage or changing a charge applied to the addressable pixels 104, for instance via a power source (e.g., primary battery cell(s), secondary battery cell(s), ultra- or super-capacitor array, fuel cell(s)) 109.

The control subsystem 106 may include one or more nontransitory processor-readable storage media 112 which store at least one of processor-executable instructions and, or data, which when executed by the at least one of processor 108, cause the at least one of processor 108 to control operation of the appearance configuration device 102a and garment 100a, for instance controlling the appearance of the plurality of addressable pixels 104. For example, the control subsystem 106 may include one or more non-volatile memories, for instance Read Only Memory (ROM) 112a, Flash memory, electronically programmable erasable memory (EEPROM), etc. Also for example, the control subsystem 106 may include one or more persistent storage media (not shown), which may include, without limitation, magnetic storage devices such as hard disc drives, electromagnetic storage devices such as memristors, molecular storage devices, quantum storage devices, electrostatic storage devices such as solid state drives, and the like. As a further example, the control subsystem may include one or more one or more volatile memories, for instance Random Access Memory (RAM) 112b. Also for example, the control subsystem 106 may include one or more spinning media storage devices (not shown), for instance one or more magnetic hard disk drives and, or optical disk drives. As a further example, the control subsystem may include one or more solid state drives (SSDs) (not shown).

One or more of nontransitory processor-readable storage media 112 may be internal to the appearance configuration device. One or more of nontransitory processor-readable storage media 112 may be external to the appearance configuration device. One or more of nontransitory processor-readable storage media 112 (e.g., USB thumb drives, memory sticks, or the like) may be removably receivable by the appearance configuration device. The appearance configuration device 102a may include interfaces or device controllers (not shown) communicably coupled between nontransitory processor-readable storage media and the other components of the control subsystem 106. Those skilled in the relevant art will appreciate that other types of nontransitory processor-readable storage media may be employed to store digital data accessible by a computer or processor, such as magnetic cassettes, flash memory cards, RAMs, ROMs, smart cards, etc.

The control subsystem 106 may include one or more switches S₁, S₂, operable to receive user input. The switches S₁, S₂, can take any of a large variety of forms, for example contact switches, push button switches, key switches, momentary switches, rocker switches, and, or relay switches. The switches S₁, S₂, may be assessable by a wearer of the garment, and operable to, for example, toggling through a plurality of defined visual appearances.

The control subsystem 106 may include one or more sensors or transducers T₁, T₂, operable to sense or identify various environmental characteristics, for instance proximity, location, movement, acceleration, and, or orientation. The sensors or transducers T₁, T₂, can take any of a large variety of forms, for example PRI motion sensors, proximity sensors, one-, two- or three-axis accelerometers, capacitive sensors, inductive sensors, resistance sensors, temperature sensors, humidity sensors, ferrous metal sensors, magnetic sensors (e.g., Reed sensor). The sensors or transducers T₁, T₂, may be an integral part of a circuit board or housing that holds other components of the control subsystem 106, or can be located remotely therefrom, for example at other locations on the garment 100a, or locations associated with a delivery vehicle or elsewhere.

In some implementations, the appearance configuration device 102a operates in an environment using one or more of the network interfaces to optionally communicably couple to one or more remote computers, servers, display devices, satellites, and/or other devices via one or more communications channels, for example, one or more networks such as the network. These logical connections may facilitate any known method of permitting computers to communicate, such as through one or more LANs, WANs, cellular networks. Any such networking environments may be employed including wired and wireless enterprise-wide computer networks, intranets, extranets, and the Internet.

The control subsystem 106 may include one or more transmitters, receivers, or transceivers. For example, the control subsystem may include one or more radios, for instance one or more cellular radios 114a and associated antennae 116a for communications via one or more cellular networks (e.g., GSM, TDMA, CDMA), one or more wireless local area networks (W-LANs) radios (e.g., WI-FI® radios) 114b and associated antennae 116b, and, or, one or more wireless short range communications channel radios (e.g., BLUETOOTH® radios) 114c and associated antennae 116c (radios collectively 114, antenna collectively 116). Such allows the processor(s) 108 to receive instructions and, or information, and to control operation accordingly. For example, as discussed in detail elsewhere herein, the processor(s) 108 can receive information that identifies a current location of the garment 102a, for instance with respect to a destination, a geo-fenced area, or a vehicle, and automatically update an appearance of the garment 102a accordingly.

The control subsystem 106 may include one or more communications channels, for example one or more buses 118 that communicably couple various components of the control subsystem 106 including the processor(s) 108, drive circuitry 110, nontransitory processor-readable storage media 112, switches S₁, S₂, sensors or transducers T₁, T₂ and, or transmitters, receivers, transceivers or radios 114. The bus(es) 118 can employ any known bus structures or architectures, including a memory bus with memory controller, a peripheral bus, a local bus, and, or a power bus. Some implementations may employ separate buses 118 for data, instructions and power.

The nontransitory processor-readable storage media 112 provides storage of processor-executable instructions, data structures, program modules and other data for the appearance configuration device. Program modules may, for example, include one or more of a basic input/output system (“BIOS”), an operating system, one or more application programs, other programs or modules, and, or drivers, along with associated program data.

For example, one or more of the nontransitory processor-readable storage media (e.g., ROM 112a) 112 may store a basic input/output system (“BIOS”), which contains basic routines that help transfer information between elements within the appearance configuration device, such as during start-up.

For example, one or more of the nontransitory processor-readable storage media (e.g., ROM 112a) 112 may store application programs.

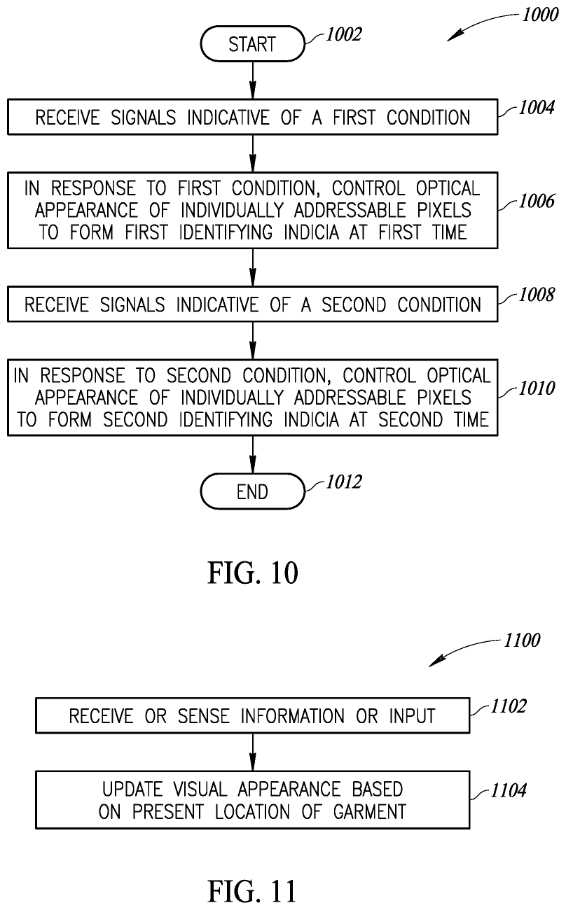

The application programs may include, for example, one or more machine executable instruction sets (i.e., appearance control module) that makes determinations of whether one or more defined conditions, if any, have been met, and that controls the appearance presented by the appearance configuration device by control of a plurality of addressable pixels thereof, for instance via drive circuitry. Various methods performable via execution of the processor-executable instructions and data of the appearance control module are set out in the flow diagrams of FIGS. 10-26, and discussed below.

The application programs may include, for example, one or more machine executable instruction sets (i.e., input handling module) that monitors one or more of switches, sensors, transducers, for input information or signals, which optionally processes the input or signals, and which provides input or processed input to the appearance control module.

The application programs may include, for example, one or more machine executable instruction sets (i.e., communications handling module) that monitors one or more of: receivers, transceivers, radios, network interfaces or other communications channels for incoming information (i.e., information being received by the appearance configuration device from an external source). Such can include receiving positioning information via a positioning system (e.g., GPS receiver). The one or more machine executable instruction sets (i.e., communications handling module) may also controls one or more of: transmitters, transceivers, radios, network interfaces or other communications channels to transmit outgoing information (i.e., information being transmitted from the appearance configuration device to an external destination).

FIG. 1B shows an appearance configuration device 102b, according to at least one illustrated implementation. In particular, FIG. 1B shows a rear or back surface 120 of a plurality of addressable pixels 104 and a rear or back 122 of the control subsystem 106, which are each attachable to a portion of a layer of a garment 100b. Some aspects of the appearance configuration device 102b are similar, or even identical to those illustrated and described with reference to FIG. 1A. Those aspects that are similar, or even identical to those illustrated and described with reference to FIG. 1A, are identified with the same reference numbers used in FIG. 1A. In the interest of conciseness, only the most significant differences between the appearance configuration device 102a of FIG. 1A and the appearance configuration device 102b of FIG. 1B are described below.

As illustrated, the plurality of addressable pixels 104 form a distinct fabric or layer, that is selectively detachably attachable to at least a portion of a garment 100b. For example, a back or rear surface 120 of the plurality of addressable pixels 104 may carry one or more fasteners, for instance one or more snaps 124 (only once called out to prevent clutter), hook and loop fastener 126, buttons, zippers, etc. This advantageously allows the addressable pixels 104 to be removed from the layer of the garment 100b, for instance to permit the garment 100b to be cleaned or laundered without risking damage to the addressable pixels, or to replace a faulty unit or set of addressable pixels 104.

As illustrated, the control subsystem 106 forms a distinct unit that is selectively detachably attachable to at least a portion of a garment 100b. For example, a rear or back 122 of the control subsystem 106 or housing thereof, may carry one or more fasteners, for instance one or more snaps 128, hook and loop fastener 130, buttons, zippers, etc. This advantageously allows the control subsystem 106 to be removed from the remainder of the garment 100b, for instance to permit the garment 100b to be cleaned or laundered without risking damage to the control subsystem 106, or to replace a faulty control subsystem 106, or to provide a replacement control subsystem 106 with new firmware.

As illustrated, the appearance configuration device 102b includes at least one communications channel 132 that is selectively detachably coupleable to at least one of the plurality of addressable pixels 104 or the control subsystem 106 to operatively couple the control subsystem 106 to control a visual appearance of a garment 100b produced by the addressable pixels 104. The communications channel 132 may take the form a wired bus, for instance with a plurality of individual electrically conductive serial communications paths, and an insulating substrate (e.g., ribbon cable). The communications channel 132 is preferably flexible, and capable withstanding repeated flexing without resulting in a discontinuity or failure. The communications channel 132 is preferably thin, to blend seamlessly into the garment 100b. The communications channel 132 may be physical attached to the garment 100b along a length or a portion of the length of the communications channel 132, for instance by a releasable adhesive, cable ties, etc. (not illustrated). While the communications channel 132 is preferably detachably attached to the garment 100b, in some implementations the communications channel 132 may be fixedly attached to the garment 100b.

In some implementations, the plurality of addressable pixels 104 and, or the control subsystem 106 may have a respective port 134a, 134b to which the communications channel 132 is physically and communicatively detachably coupleable. The ports 134a, 134b may be compliant with a physical and communications specification (e.g., USB® specification, Thunderbolt® specification, Apple® Lightening® cable specification). This advantageously allows one or more of the communications channel 132, the plurality of addressable pixels 104, and, or the control subsystem 106 to be removed from the remainder of the garment 100b, for instance to permit the garment to be cleaned or laundered without risking damage to the plurality of addressable pixels 104 or to the control subsystem 106, or to replace either the plurality of addressable pixels 104 or the control subsystem 106.

FIG. 1C shows an appearance configuration device 102c, according to at least one illustrated implementation. In particular, FIG. 1C shows a plurality of addressable pixels 104 attached to an outer or visible layer of a garment 100c. FIG. 1C also shows the control subsystem 106 or a housing thereof, attached to be garment 100b via a pouch or pocket, for example a mesh pouch or pocket 136. Some aspects of the appearance configuration device 102c are similar, or even identical to those illustrated and described with reference to FIG. 1A or 1B. Those aspects that are similar, or even identical to those illustrated and described with reference to FIG. 1A or 1B, are identified with the same reference numbers used in FIG. 1A or 1B. In the interest of conciseness, only the most significant differences between the appearance configuration devices 102a, 102b of FIGS. 1A and 1B, respectively, and the appearance configuration device 102c of FIG. 1C are described below.

As noted above, FIG. 1C shows a plurality of addressable pixels 104 provided as a fabric or material layer attached to an outer or visible layer of a garment 100c. As previously explained, the plurality of addressable pixels 104 may be detachably attached to the outer or visible layer of a garment. Alternatively, the plurality of addressable pixels 104 may be fixedly attached to the outer or visible layer of a garment 100c, or may even form the garment 100c itself with, or without, additional layers of fabric or materials, for instance composing an integral unitary or monolithic single piece construction. As also noted the control subsystem 106 or a housing thereof, attached to be garment 100c via a pouch or pocket, for example a mesh pouch or pocket 136. A portion of the mesh pouch or pocket 136 may, for example, be fixedly attached the remainder of the garment 100c, for example being fixedly attached along three sides to a fabric or material layer of the garment 100c. A portion (e.g., one side) 138 of the mesh pocket or pouch 136 may be left open to allow the control subsystem 106 to be repeatedly removed and inserted into the mesh pouch or pocket 136. One or more fasteners, for instance a tongue and groove press and seal type “zippers” 140 commonly associated with re-sealable zip seal plastic bags (e.g., ZIPLOCK® bags) or other fasteners (e.g., snaps, buttons, zipper) may be provided to allow the open portion 138 to be selectively closed, to securely retain the control system 106 or housing thereof in the mesh pouch or pocket 136 during use. While illustrated as a mesh pouch or pocket 136, some implementations may employ a non-mesh material, for example a woven material or even a material that provides environmental protection to the control subsystem 106, for example being water resistant or water impervious. In such implementations, a watertight seal provided by a tongue and groove press and seal type “zippers” 140 may be particularly desirable.

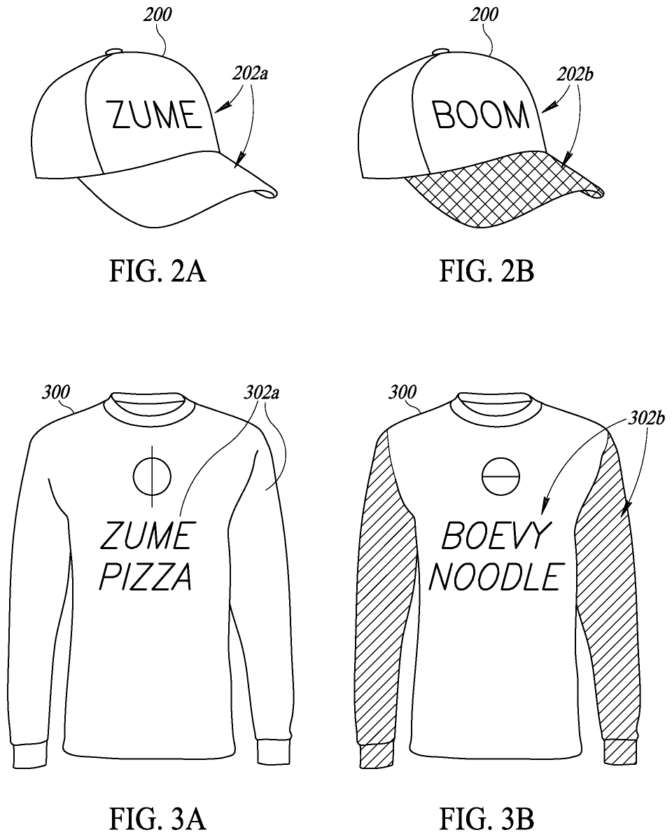

FIG. 2A shows a garment at a first time, the garment taking the form of a hat 200, according to at least one illustrated implementation

The hat 200 comprises an appearance configuration device, for example the appearance configuration device as illustrated and described with reference to FIGS. 1A-1C. The appearance configuration device is operable to cause presentation of a first optical appearance (e.g., a first color scheme, logo, name, branding, insignia, graphic, and, or text) 202a at the first time, for instance in respect to a condition or stimulus or input.

FIG. 2B shows the hat 200 of FIG. 2A at a second time, according to at least one illustrated implementation,

The appearance configuration device is operable to cause presentation of a second optical appearance (e.g., a second color scheme, logo, name, branding, insignia, graphic, and, or text) 202b at the second time, for instance in respect to a condition or stimulus or input, according to at least one illustrated implementation.

FIG. 3A shows a garment at a first time, the garment taking the form of a shirt 300, according to at least one illustrated implementation

The shirt 300 comprises an appearance configuration device, for example the appearance configuration device as illustrated and described with reference to FIGS. 1A-1C. The appearance configuration device is operable to cause presentation a first optical appearance (e.g., a first color scheme, logo, name, branding, insignia, graphic, and, or text) 302a at the first time, for instance in respect to a condition or stimulus or input, according to at least one illustrated implementation.

FIG. 3B shows the shirt 300 of FIG. 3A at a second time, according to at least one illustrated implementation

The appearance configuration device is operable to cause presentation of a second optical appearance (e.g., a second color scheme, logo, name, branding, insignia, graphic, and, or text) 302b at the second time, for instance in respect to a condition or stimulus or input, according to at least one illustrated implementation.

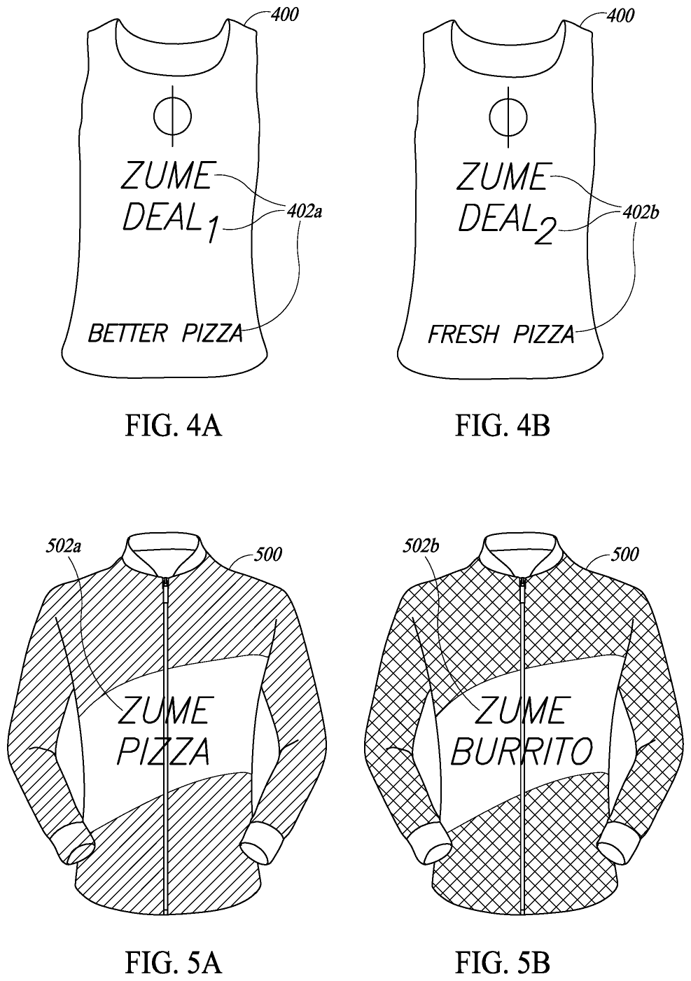

FIG. 4A shows a garment at a first time, the garment taking the form of a vest 400, according to at least one illustrated implementation

The vest 400 comprises an appearance configuration device, for example the appearance configuration device as illustrated and described with reference to FIGS. 1A-1C. The appearance configuration device is operable to cause presentation a first optical appearance (e.g., a first color scheme, logo, name, branding, insignia, graphic, and, or text) 402a at the first time, for instance in respect to a condition or stimulus or input, according to at least one illustrated implementation.

FIG. 4B shows the vest 400 of FIG. 4A at a second time, according to at least one illustrated implementation

The appearance configuration device is operable to cause presentation of a second optical appearance (e.g., a second color scheme, logo, name, branding, insignia, graphic, and, or text) 402b at the second time, for instance in respect to a condition or stimulus or input, according to at least one illustrated implementation.

FIG. 5A shows a garment at a first time, the garment taking the form of a jacket 500, according to at least one illustrated implementation

The jacket 500 comprises an appearance configuration device, for example the appearance configuration device as illustrated and described with reference to FIGS. 1A-1C. The appearance configuration device is operable to cause presentation a first optical appearance (e.g., a first color scheme, logo, name, branding, insignia, graphic, and, or text) 502a at the first time, for instance in respect to a condition or stimulus or input, according to at least one illustrated implementation.

FIG. 5B shows the jacket 500 of FIG. 5A at a second time, according to at least one illustrated implementation

The appearance configuration device is operable to cause presentation of a second optical appearance (e.g., a second color scheme, logo, name, branding, insignia, graphic, and, or text) 502b at the second time, for instance in respect to a condition or stimulus or input, according to at least one illustrated implementation.

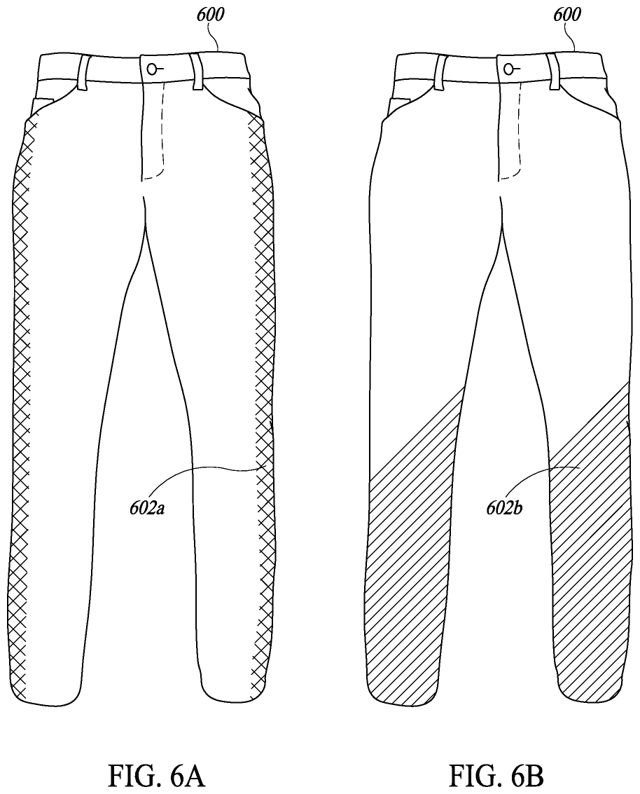

FIG. 6A shows a garment at a first time, the garment taking the form of a pants or slacks 600, according to at least one illustrated implementation

The pants or slacks 600 comprises an appearance configuration device, for example the appearance configuration device as illustrated and described with reference to FIGS. 1A-1C. The appearance configuration device is operable to cause presentation a first optical appearance (e.g., a first color scheme, logo, name, branding, insignia, graphic, and, or text) 602a at the first time, for instance in respect to a condition or stimulus or input, according to at least one illustrated implementation.

FIG. 6B shows the pants or slacks 600 of FIG. 6A at a second time, according to at least one illustrated implementation

The appearance configuration device is operable to cause presentation of a second optical appearance (e.g., a second color scheme, logo, name, branding, insignia, graphic, and, or text) 602b at the second time, for instance in respect to a condition or stimulus or input, according to at least one illustrated implementation.

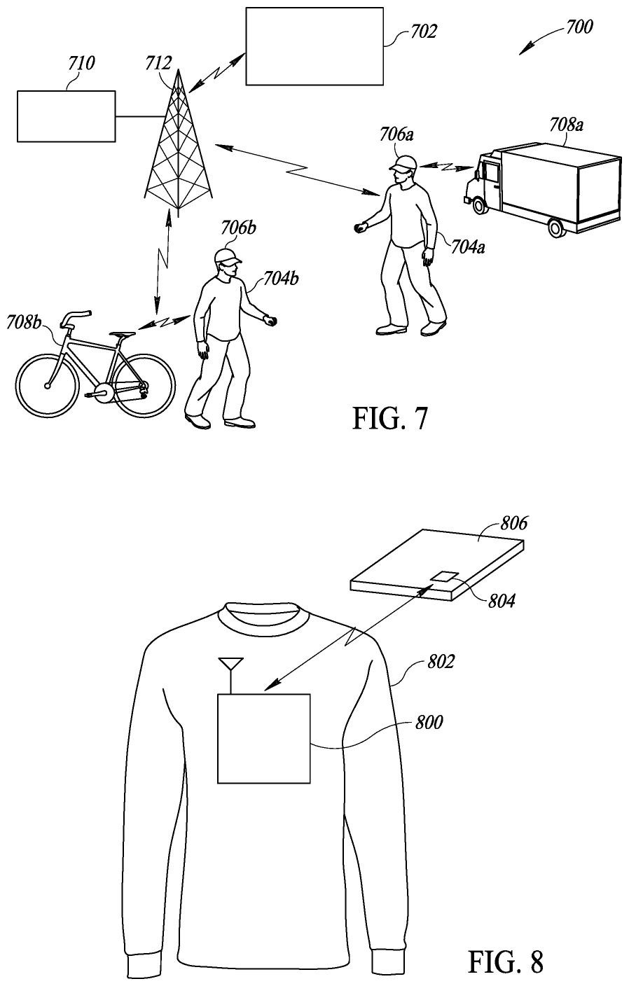

FIG. 7 shows an environment 700 in which one or more appearance configuration devices according to FIGS. 1A-1C may be employed, including one or more hub systems, one or more individuals who delivery or vend items or render services in one or more geographical regions, one or more vehicles used to deliver or vend items or make service calls, one or more destinations, and one or more geo-fenced areas, according to at least one illustrated implementations.

The environment 700 may include one or more dispatch centers or hubs 702. The dispatch centers or hubs 702 can, for example, serve as a location from which individuals and, or vehicles are dispersed to delivery or vend items, or to make services calls to render services. The dispatch centers or hubs 702 can, for example take the form of a warehouse, commissary, kitchen, restaurant, supermarket, big “box” store (e.g., COSTCO®, HOME DEPOT®, LOWES®, BEST BUY®), or other retail establishment. For example, the dispatch centers or hubs 702 can stock vehicles with raw or pre-assembled food items, or partially cooked or fully cooked food items, for delivery to customers in response to orders, or to be vended (e.g., food truck operation) via the vehicle or vended via a kiosk or locker system which is stocked via the vehicle. Also for example, the dispatch centers or hubs 702 can stock vehicles with items for delivery to customers in response to orders, or to be vended (e.g., food truck operation) via the vehicle or vended via a kiosk or locker system which is stocked via the vehicle. As a further example, the dispatch centers or hubs 702 can stock vehicles with tools and, or, parts for use in service calls.

The environment 700 may include one or more individuals 704a, 704b (two shown, collectively 704) who wear one or more garments 706a, 706b (two shown, collectively 706) which are selectively operable to present two or more distinct optical appearances (e.g., a first color scheme, logo, name, branding, insignia, graphic, and, or text). The garments 706 may, for example, comprise an adaptive uniform that can adjust its optical appearance based on the specific items being delivered or vended, and, or, the specific services being rendered.

The environment 700 may include one or more vehicles 708a, 708b (two shown, collectively 708), which can be used by the individuals 704 to reach various destinations, for example destinations on a delivery route, a service call route, or locations where the individual and vehicle will be stationed to vend items or render services to multiple customers. The vehicles 708 may take any of a wide variety of forms. For example, the vehicles 708 may include motor vehicles, for instance trucks, vans, cars, motorcycles, and, or scooters. The vehicles 708 may include human-powered vehicles, for instance bicycles or tricycles, or semi-human powered vehicles, for instance motor assisted bicycles. The vehicles 708 can include waterborne and airborne vehicles. The vehicles 708 may be non-autonomous, i.e., completely controlled by a human operator or driver. The vehicles 708 may be autonomous, i.e., completely controlled without input from a human operator or driver. The vehicles 708 may be semi-autonomous, i.e., partially controlled by a human operator or driver and partially controlled by an on-board or remote system.

Optionally, the vehicles 708 can include one or more display screens, which are selectively operable to present two or more distinct optical appearances (e.g., a first color scheme, logo, name, branding, insignia, graphic, and, or text). For example, the vehicles 708 may be wrapped in one or more pieces of electronic paper, or a flexible OLED display screen. The vehicles 708 may, for example, comprise adaptive signage that can adjust its optical appearance based on the specific items being delivered or vended, and, or, the specific services being rendered via the vehicle. Such is described in more detail in U.S. patent applications Ser. No. 62/531,131, filed Jul. 11, 2017; Ser. No. 62/531,136, filed Jul. 11, 2017; and Ser. No. 62/628390, filed Feb. 9, 2018.

The dispatch centers or hubs 702 may communicate with the of the garments 706 and, or communicate with the vehicles 708 via any number of communications channels. One such communications channel may be a cellular network, represented by a base station 710 and associated antenna 712, for instance a cellular network operated by a third party cellular services provider (e.g., VERIZON, ATT, T-Mobile). Such can allow information to be collected, for instance a location of the garment 706 and, or vehicle 708, a type of item being delivered or vended or type of service to be rendered, a proximity of an individual wearing the garment to a specific vehicle or a specific item, etc. Such can allow commands or instructions to be sent, for example, sent to one or more appearance configuration devices associated with respective garments 706, and, or to one or more vehicles 708. While a cellular network 710, 712 is illustrated, other communications channels can be employed in addition to, or in lieu of, a cellular communications network. For example, communications can be provided via one or more of the Internet, wide area networks (WANs), local area networks (LANs), WI-FI® networks, BLUETOOTH® communications channels, etc. In some implementations, communication connections may be one or more of parallel cables or serial cables capable of high speed communications, for instance, via one or more of FireWire®, Universal Serial Bus® (USB), Thunderbolt®, Gigabit Ethernet®, a Canbus, a Modbus, or any other type of standard or proprietary communication linked interface using standard and/or proprietary protocols. In some implementations, the communication connections may include optical fiber. In some implementations, the communication connections may include a wireless transceiver that communicates wirelessly with the on-board control system 418 via a short-range wireless communications protocol (e.g., Bluetooth®, Bluetooth® Low Energy, WIFI®, NFC).

FIG. 8 shows an appearance configuration device 800 of a garment 802 communicating with a wireless transponder 804 carried by an item or packaging 806, according to at least one illustrated implementation

While the garment 802 is illustrated as a shirt, the garment 802 may take any of a large variety of forms. The garment 802 includes the appearance configuration device 800, for example attached thereto or as an integral part thereof, the appearance configuration device 800 may, for example, be one of the appearance configuration devices illustrated and described with reference to FIGS. 1A-1C. The appearance configuration device 800 is operable to cause presentation a first optical appearance (e.g., a first color scheme, logo, name, branding, insignia, graphic, and, or text) at the first time, for instance in respect to a condition or stimulus or input, according to at least one illustrated implementation.

As illustrated, the item or packaging 806 may include one or more wireless transponders 804, for example one or more passive wireless transponders for instance passive radio frequency identification (RFID) transponders. The wireless transponder 804 may store information including, for example, a unique identifier. In some implementations, the wireless transponder store information additional information. For example, the wireless transponder 804 may store an identifier that identifies the item and, or type of item. Also for example, the wireless transponder 804 may store delivery information, for instance a delivery location or address, a name of a customer or person authorized to accept delivery, and, or delivery specific instructions, for instance whether and where to leave the item 806, whether a signature is required, etc. Also for example, the wireless transponder 804 may store delivery vendor information, for instance a name of the vendor, cost of the item 806, instructions for return of the item 806 for example if the item 806 cannot be successfully delivered, etc. As a further example, the wireless transponder 804 may store courier information, for instance a delivery route, tracking number, and, or, a name of a customer or person authorized to accept delivery. Alternatively, instead of storing the above information via the wireless transponder 804, the unique identifier may be logically associated (e.g., pointer, key) with any of the above information via one or more data stores (e.g., relational databases).

The appearance configuration device 800 may also be capable of determining a proximity to the wireless transponder(s) 804 and hence to an item or packaging. For example, simply detecting a wireless transponder 804 can indicate that the appearance configuration device 800, and hence the garment 802 and individual wearing the garment 802, are within some defined proximity of the item or packaging 806. The defined proximity is strongly influenced by the type of wireless transponder 804, the wireless transponder interrogator (e.g., radio, antenna(s)), and may, for example be approximately 1 meter, 3 meters, 10 meters. Additionally or alternatively, where multiple antennas are employed, the appearance configuration device 800 or some other processor-based device (e.g., a server remotely located from the appearance configuration device 800) can employ trilateration to determine a position relative to the item or packaging.

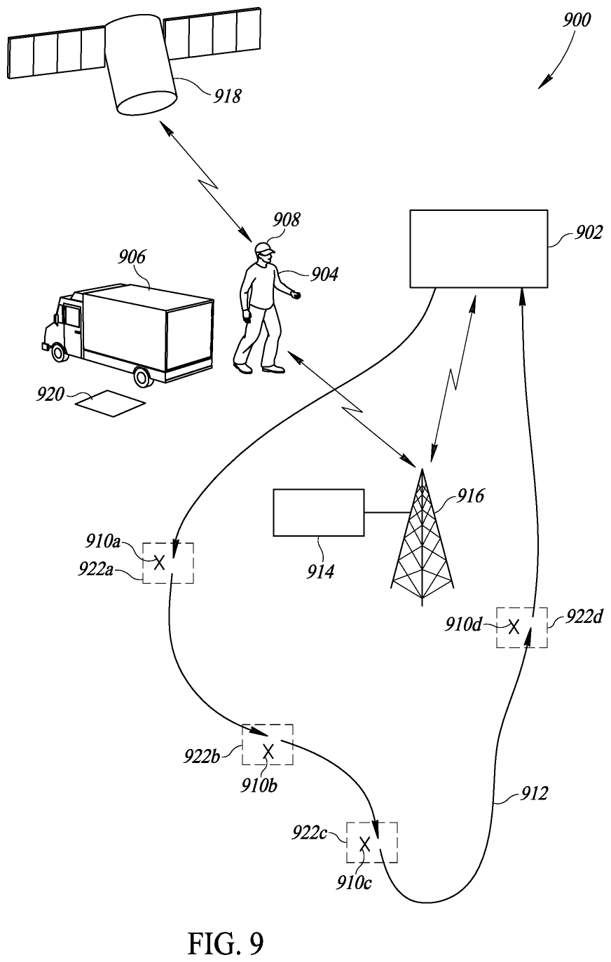

FIG. 9 shows an environment 900 in which one or more appearance configuration devices according to FIGS. 1A-1C may be employed, including one or more hub systems 902, one or more individuals 904 (only one shown) who delivery or vend items or render services in one or more geographical regions, one or more vehicles 906 (only one shown) used to deliver or vend items or make service calls, one or more destinations, and one or more geo-fenced areas, according to at least one illustrated implementations. The individuals 904 may wear one or more garments 908 (only one shown), one or more of which carries or includes appearance configuration device (not shown in FIG. 9). Some aspects of the environment 900 are similar, or even identical to those illustrated and described with reference to FIG. 7. Those aspects that are similar, or even identical to those illustrated and described with reference to FIG. 7, are identified with the same reference numbers used in FIG. 7. In the interest of conciseness, only the most significant differences between the environment of FIG. 7 and the environment of FIG. 9 are described in detail below.

The environment 900 may include one or more dispatch centers or hubs 702, for example as discussed above with reference to FIG. 7.

The environment 900 may include one or more individuals 904 who wear one or more garments 908 which are selectively operable to present two or more distinct optical appearances (e.g., a first color scheme, logo, name, branding, insignia, graphic, and, or text), for example as discussed above with reference to FIG. 7. The garments 908 may, for example, comprise an adaptive uniform that can adjust its optical appearance based on the specific items being delivered or vended, and, or, the specific services being rendered.

The environment 900 may include one or more vehicles 906, which can be used by some or all of the individuals 904 to reach various destinations 910a, 910b, 910c, 910d, (collectively 910, for example destinations on a delivery route, a service call route, or locations where the individual and vehicle will be stationed to vend items or render services to multiple customers (collectively route 912 illustrated by single headed arrows going to and from destinations 910a-910d, for example as discussed above with reference to FIG. 7.

The dispatch centers or hubs 702 may communicate with the appearance configuration device of the garments 908 and, or communicate with the vehicles 906 via any number of communications channels (represented by base station 914 and associated antenna 916), for example as discussed above with reference to FIG. 7. Additionally, FIG. 9 illustrates a satellite 918 that represents a system that provides satellite communications and, or global positioning (e.g., GPS, GLONASS, GNSS) information. Such can advantageously be employed in determining a location of an appearance configuration device and associated garment 908 and wearer of the associated garment 908. Such can advantageously be employed in determining a location of a vehicle 906. Such can advantageously be employed in determining a location of an item or packaging for the item 920. Such can advantageously be employed in determining a delivery location, vending location, and, or location of a service call at which services will be rendered, locations (e.g., destinations) collectively 910. Such can advantageously be employed in tracking an individual 904, vehicle 906 and, or item 920.

The individual 904 wearing the garment 908 may traverse a route 912 through the environment 900. The individual 904 may, or may not, employ one or more vehicles 906 in traversing the route 912. In some instances, the individual 904 may use a vehicle 906 to traverse one or more portions of the route 912, while traversing other portions of the route 912 on foot. The route 912 may be predefined, for instance defined before the individual 904 starts off on the route 912. Alternatively, the route 912 can be determined dynamically, for instance defined at least in part after the individual 904 starts off on the route 912, and even optionally updated in real-time during the traversal of the route 912 by the individual 904.

The position or location of the individual 904 wearing the garment 908 may be tracked periodically, aperiodically, or even continuously, while the individual 904 wearing the garment 908 traverses the route 912. For example, the position or location may be tracked via a satellite 918 based positioning system, or via a variety of other methods (e.g., trilateration, triangulation). For instance, the appearance configuration device (not illustrated in FIG. 9) may include a positioning receiver (e.g., GPS receiver or radio) and, or the vehicle 906 may include a positioning receiver (e.g., GPS receiver or radio). The receiver determines a position or location at various instances of time. The determined position or location information can be used by the appearance configuration device to determine or trigger a presentation of, or a change in, the visual appearance of one or more garment 908. The information can be used directly by the appearance configuration device, which determines which set of visual appearance to present based on the current or anticipated position or location of the garment. Alternatively, the information can be used by another device (e.g., server remotely located from the appearance configuration device), which determines which set of visual appearance to present based on the current or anticipated position or location of the garment 908, and which provides signals to control operation of the appearance configuration device to cause presentation of the appropriate visual appearance.

For example, the individual 904 wearing the garment 908 may start at a dispatch center or hub 702, either with or without a vehicle 906. While at the dispatch center or hub 702, the individual 904 may pick up items 920 to be delivered or vended, or tools or supplies for service calls. In some implementations, a vehicle 906 may be loaded with the items, tools or parts 920, and the individual 904 simply picks up the vehicle 906 at the dispatch center or hub 702.

The individual 904 may travel to a first location 910a, for example a first destination at which an item 920 is to be delivered or vended, or a service is to be rendered. The first location 910a may have an associated geo-fence or boarder, represented by broken-line box 922a. The individual 904 may then travel to a second location 910b, for example a second destination at which an item is to be delivered or vended, or a service is to be rendered. The second location 910b may have an associated geo-fence or boarder, represented by broken-line box 922b. The individual 904 may travel to a third location 910c, for example a third destination at which an item is to be delivered or vended, or a service is to be rendered. The third location 910c may have an associated geo-fence or boarder, represented by broken-line box 922c. The individual 904 may travel to a fourth location 910d, for example a fourth destination at which an item is to be delivered or vended, or a service is to be rendered. The fourth location 910d may have an associated geo-fence or boarder, represented by broken-line box 922d. The individual 904 wearing the garment 908 may the return to the dispatch center or hub 702, either with or without a vehicle 906, for example at the end of a route 912, end of a work day, or to pick up additional items, tools or parts before starting another route.

In some implementations, individual items 920 may be prepared during transit, for example between two or more locations 910. For example, food items may be cooked during transit, and cooking may be timed or otherwise controlled (e.g., temperature) such that the food item finished cooking at or at least proximate to arrival at a defined destination. For example, a transit time from a given location to a defined location may be determined, and may even be dynamically updated during transit. The resulting estimated time of arrival (ETA) may be used to control one or more cooking units (e.g., ovens).

In use, any of a variety of stimulus can trigger an appearance configuration device to cause presentation of a given visual appearance, for example based on the stimulus meeting some defined criteria. For example, the appearance configuration device may be responsive to detection of a departure of a garment 908 worn by an individual 904 from one location, for instance departure from the dispatch center or hub 702, departure from a vehicle 906, departure of a vehicle 906, or departure from a previous destination. Also for example, the appearance configuration device may be responsive to detection of an arrival of a garment 908 worn by an individual 904 at a location, for instance arrival at a destination (e.g., delivery destination, vending destination, service call destination) 910, or arrival at a vehicle 906, or arrival of a vehicle 906. Also for example, the appearance configuration device may be responsive to detection of arrival within a defined distance or a defined travel time of a location (e.g., delivery destination, vending destination, service call destination) 910, or upon reaching or entering a geo-fenced area 922a, 922b, 922c, 922d, for example a geo-fenced area 922a, 922b, 922c, 922d that surrounds a location (e.g., delivery destination, vending destination, service call destination vehicle) 910. Also for example, the appearance configuration device may be responsive to detection of an item, tool or supply 920 in a proximity or defined proximity of a garment 908 worn by an individual 904. Also for example, the appearance configuration device may be responsive to detection of a vehicle 906 in a proximity or defined proximity of a garment 908 worn by an individual 904.

As described above, any one or more stimulus or conditions may be used to trigger when an appearance of one or more garments should change. The stimulus or conditions may not only determine when the appearance of the garment should change, but in some instances may determine what visual appearance should be presented. In other instances, one or more stimulus or conditions may determine when the appearance of the garment should change, while the item being delivered or vended or the service to be provided may determine what visual appearance should be presented.

FIG. 10 shows a method 1000 of operation of a device, according to one illustrated implementation. The method 1000 can, for example, be executed by one or more processor-based devices, for instance an appearance configuration device such as described with reference to FIGS. 1A-1C.

The method 1000, and other methods illustrated and/or described herein may advantageously be performed autonomously, for example without specific user input or intervention. For example, various sensors or transducers may monitor an environment and produce signals indicative of aspects of the environment, for instance absolute position, relative position, distance, time, speed, proximity. Sensors or transducers may additionally, or alternatively, read information, for instance information stored in one or more wireless transponders, for example wireless transponders associated with items to be delivered, tools and, or supplies to be used in rendering services, wireless transponders associated with vehicles to be used in delivering or vending items or making service calls, wireless transponders associated with garments and, or with individuals. Such can advantageously allow an appearance of a garment to be automatically adjusted to match or correspond to any given situation or set of conditions. For example, an appearance of a uniform can automatically and, or autonomously adjust based on: a current location of the wearer of the uniform, a proximity to a location, for instance a destination such as a delivery destination, based on an item to be delivered or vended or a service to be rendered, a seller of an item or service, a buyer of an item or service, a courier charged with delivering an item, a type of time to be delivered, etc. In some implementations, one or more user inputs can be employed, although completely autonomous operation (i.e., in response to detected conditions without human user input beyond for example ordering the item or services or piloting a vehicle or walking toward a destination) is preferred.

The method 1000 starts at 1002, for example in response to being turned on, receipt of a user input, receipt of a signal, or a call from a calling routine or program.

At 1004, a processor-based device receives signals indicative of a first condition. The signals may be received or collected via one or more sensors, for example sensors that are part of an appearance configuration device or otherwise attached to a garment. The signals may be received from one or more processor-based systems that are located remotely from the garment and associated appearance configuration device. The signals may provide raw information for which the processor-based device may determine whether a defined condition has be fulfilled or satisfied. For example, the signals may specify a current location, and the processor-based device determines whether the current location is at or within a defined distance of a target location. The signals may provide processor information, for example representing a determination of whether a defined condition has be fulfilled or satisfied.

The signals may, for example, indicate a presence or a proximity to an item, a tool, or part (e.g., item to be delivered or vended, tool or part to be used in a service call). The signals may, for example, indicate a presence or a proximity to a vehicle (e.g., delivery vehicle). The signals may, for example, indicate a departure or other movement from a location (e.g., dispatch center, hub). The signals may, for example, indicate presence at, or proximity to, a location, for instance a destination (e.g., delivery destination, service call destination). Proximity may be defined in terms of distance over a non-straight line path, distance over a straight line path (i.e., “as the crow flies”), or estimated travel time. The signals may, for example, indicate reaching or entering a geo-fenced area, for instance a geo-fenced area associated with a destination (e.g., delivery destination, service call destination). Information identifying a location may be, for example, a set of coordinates (e.g., latitude and longitude), an address, an intersection, a defined area (e.g., within 100 feet of an arena entrance), or any other identifying information (e.g., parking lot of the local grocery store).

At 1006, in response to the first condition, one or more processor-based devices, for instance an appearance configuration device, controls an optical appearance of individually addressable pixels to form first identifying indicia at first time.

As previously explained, the first condition can be a simple existence/non-existence determination (e.g., present/absent). As previously explained, the first condition can require a more substantive determination, e.g., evaluating a current position versus a desired location or position, evaluating a travel time, determining an extent of a geo-fenced area and a relative position (e.g., within, without) the geo-fenced area.

To control an optical appearance of individually addressable pixels to form first identifying indicia at first time, the appearance configuration device or a component thereof (e.g., processor, drive circuitry) sends a set of signals to cause each of a plurality of pixel to enter a defined state. For example, the appearance configuration device or a component thereof (e.g., processor, drive circuitry) can send signals to cause each of a plurality of cells of electronic paper to enter one of two states by, for example applying an electrical potential or polarity to a pair of electrodes of the cell. The cell may be operable between two states (e.g., black, white), and the application may cause the cell to be in one of those two states. The cell remains in the state until the electrical potential or polarity is changed. Alternatively, the appearance configuration device or a component thereof (e.g., processor, drive circuitry) can send signals to cause each of a plurality of pixel of flexible OLED to emit a desired color, for example applying an electrical potential or polarity to a pair of electrodes of the pixel.

The appearance configuration device or a component thereof (e.g., processor, drive circuitry) can employ a set of drive information which may defined a number of visual appearances. Drive information may be pre-defined; that is respective sets of drive information for each of a number of visual appearances may be defined and stored in a memory of the appearance configuration device before receipt of the signals, the selected based on the signals or based on a determination of whether a defined condition is met. Alternatively, some visual appearances can be defined dynamically, for example producing a logo or color scheme that was not previously stored in a memory of the appearance configuration device before receipt of corresponding signals.

At 1008, a processor-based device receives signals indicative of a second condition. This can be similar or even identical to what occurs at 1004, although the signals themselves may be different and represent different specific information, although of the same type of information as represented at 1004.

At 1010, in response to the second condition, one or more processor-based devices, for instance an appearance configuration device, controls an optical appearance of individually addressable pixels to form first identifying indicia at first time. This can be similar or even identical to what occurs in 1006, although the visual appearance will differ in some respect.

The method 1000 may terminate at 1012 until called again, although in at least some implementations there may be numerous iterations of the various acts prior to termination.

FIG. 11 shows a method 1100 of operation of a device, according to one illustrated implementation. The method 1100 can, for example, be executed by one or more processor-based devices, for instance an appearance configuration device such as described with reference to FIGS. 1A-1C. The method 1100 may be executed as part of the execution of method 1000 (FIG. 10).

At 1102, a processor-based device receives signals or senses information or input that is indicative of a condition, for example a location of an appearance configuration device, and hence a location of an associated garment and individual wearing the associated garment.

At 1104, a processor-based device or component thereof updates a visual appearance of the garment based on a present location of the garment. For example, a processor-based device or component thereof (drive circuitry) may send a set of drive signals to set a state of one or more addressable pixels (e.g., pixels of electronic paper, pixels of flexible OLED) that is part of, or carried by the garment.

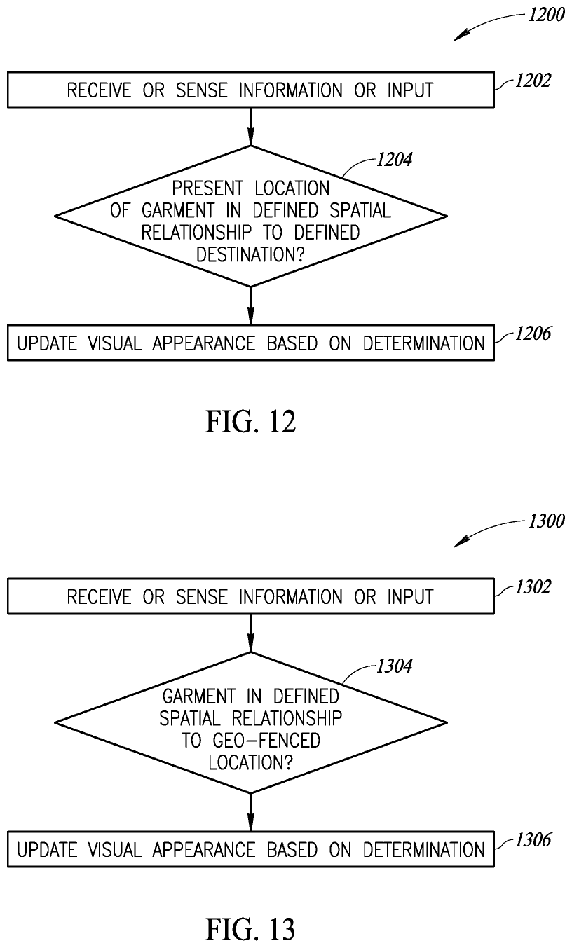

FIG. 12 shows a method 1200 of operation of a device, according to one illustrated implementation. The method 1200 can, for example, be executed by one or more processor-based devices, for instance an appearance configuration device such as described with reference to FIGS. 1A-1C. The method 1200 may be executed as part of the execution of method 1000 (FIG. 10).

At 1202, a processor-based device receives signals or senses information or input that is indicative of a condition, for example a defined spatial relationship of a location of an appearance configuration device with respect to a defined destination, and hence a defined spatial relationship of an associated garment and individual wearing the associated garment with respect to the defined destination.

At 1204, a processor-based device or component thereof determines whether a present location of the appearance configuration device, and hence the garment and individual wearing the garment, is in a defined spatial relationship with respect to a defined destination.

At 1206, a processor-based device or component thereof updates a visual appearance of the garment based at least in part on the determination whether a present location of the appearance configuration device, and hence the garment and individual wearing the garment, is in a defined spatial relationship with respect to a defined destination. For example, a processor-based device or component thereof (drive circuitry) may send a set of drive signals to set a state of one or more addressable pixels (e.g., pixels of electronic paper, pixels of flexible OLED) that is part of, or carried by the garment.

FIG. 13 shows a method 1300 of operation of a device, according to one illustrated implementation. The method 1300 can, for example, be executed by one or more processor-based devices, for instance an appearance configuration device such as described with reference to FIGS. 1A-1C. The method 1300 may be executed as part of the execution of method 1000 (FIG. 10).

At 1302, a processor-based device receives signals or senses information or input that is indicative of a condition, for example a defined spatial relationship of a location of an appearance configuration device with respect to a geo-fenced location or geo-fenced area, and hence a defined spatial relationship of an associated garment and individual wearing the associated garment with respect to the geo-fenced location or geo-fenced area.

At 1304, a processor-based device or component thereof determines whether a present location of the appearance configuration device, and hence the garment and individual wearing the garment, is in a defined spatial relationship with respect to a defined geo-fenced location or defined geo-fenced area.

At 1306, a processor-based device or component thereof updates a visual appearance of the garment based at least in part on the determination whether a present location of the appearance configuration device, and hence the garment and individual wearing the garment, is in a defined spatial relationship with respect to a defined geo-fenced location or defined geo-fenced area. For example, a processor-based device or component thereof (drive circuitry) may send a set of drive signals to set a state of one or more addressable pixels (e.g., pixels of electronic paper, pixels of flexible OLED) that is part of, or carried by the garment.

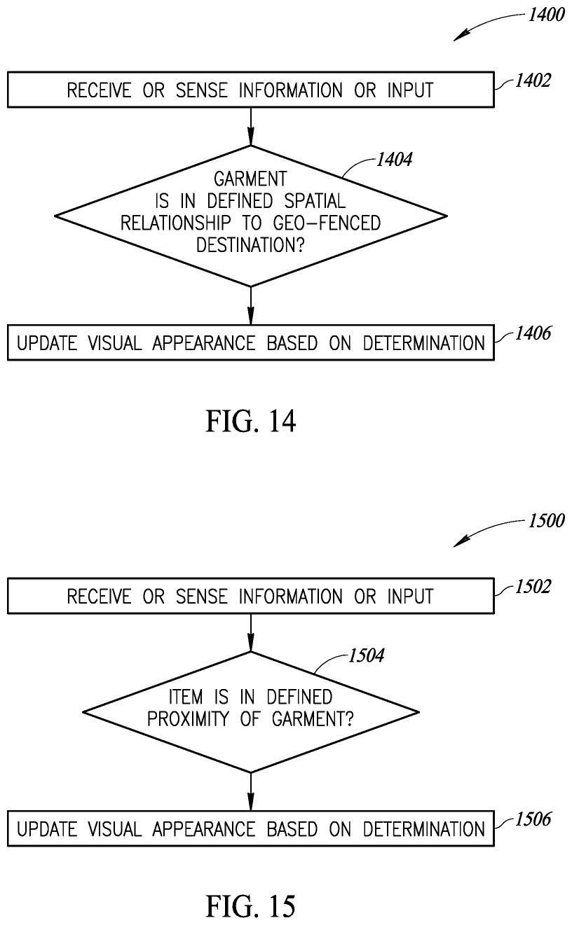

FIG. 14 shows a method 1400 of operation of a device, according to one illustrated implementation. The method 1400 can, for example, be executed by one or more processor-based devices, for instance an appearance configuration device such as described with reference to FIGS. 1A-1C. The method 1400 may be executed as part of the execution of method 1000 (FIG. 10).

At 1402, a processor-based device receives signals or senses information or input that is indicative of a condition, for example a defined spatial relationship of a location of an appearance configuration device with respect to a geo-fenced location or geo-fenced area, and hence a defined spatial relationship of an associated garment and individual wearing the associated garment with respect to the geo-fenced destination.

At 1404, a processor-based device or component thereof determines whether a present location of the appearance configuration device, and hence the garment and individual wearing the garment, is in a defined spatial relationship with respect to a defined geo-fenced destination.

At 1406, a processor-based device or component thereof updates a visual appearance of the garment based at least in part on the determination whether a present location of the appearance configuration device, and hence the garment and individual wearing the garment, is in a defined spatial relationship with respect to a defined geo-fenced destination. For example, a processor-based device or component thereof (drive circuitry) may send a set of drive signals to set a state of one or more addressable pixels (e.g., pixels of electronic paper, pixels of flexible OLED) that is part of, or carried by the garment.

FIG. 15 shows a method 1500 of operation of a device, according to one illustrated implementation. The method 1500 can, for example, be executed by one or more processor-based devices, for instance an appearance configuration device such as described with reference to FIGS. 1A-1C. The method 1500 may be executed as part of the execution of method 1000 (FIG. 10).

At 1502, a processor-based device receives signals or senses information or input that is indicative of a condition, for example a present location of an item, tool or supplies relative to a present location of an appearance configuration device, and hence a present location of an associated garment and individual wearing the associated garment.

At 1504, a processor-based device or component thereof determines whether an item, tool or supplies are in or within a defined proximity of a present location of an appearance configuration device, and hence a defined proximity of an associated garment and individual wearing the associated garment.

At 1506, a processor-based device or component thereof updates a visual appearance of the garment based at least in part on the determination whether the item, tool or supplies are in or within a defined proximity of the present location of an appearance configuration device, and hence a defined proximity of an associated garment and individual wearing the associated garment. For example, a processor-based device or component thereof (drive circuitry) may send a set of drive signals to set a state of one or more addressable pixels (e.g., pixels of electronic paper, pixels of flexible OLED) that is part of, or carried by the garment.

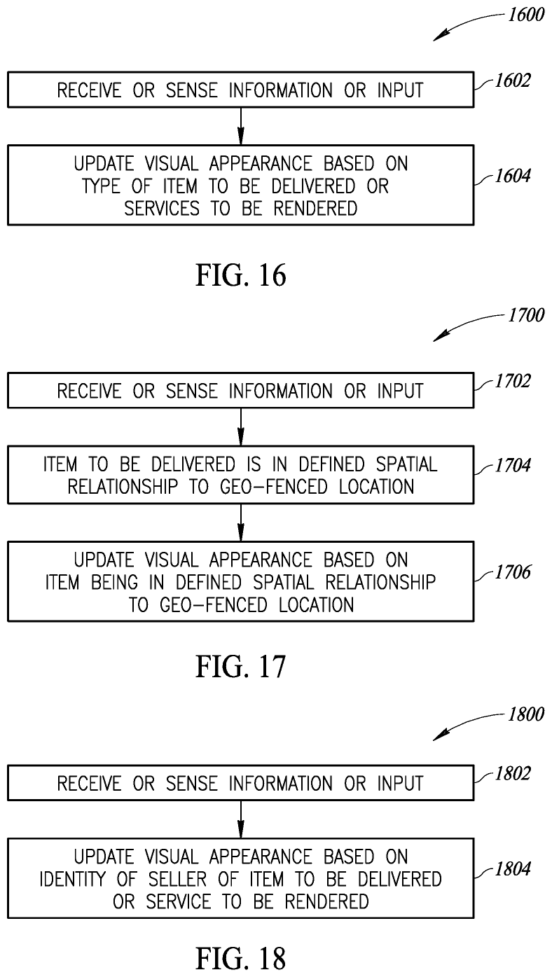

FIG. 16 shows a method 1600 of operation of a device, according to one illustrated implementation. The method 1600 can, for example, be executed by one or more processor-based devices, for instance an appearance configuration device such as described with reference to FIGS. 1A-1C. The method 1600 may be executed as part of the execution of method 1000 (FIG. 10).

At 1602, a processor-based device receives signals or senses information or input that is indicative of a condition, for example a type of item to be delivered or a type of services to be rendered.

At 1604, a processor-based device or component thereof updates a visual appearance of the garment based at least in part on the determination of the type of item to be delivered or the type of services to be rendered. For example, a processor-based device or component thereof (drive circuitry) may send a set of drive signals to set a state of one or more addressable pixels (e.g., pixels of electronic paper, pixels of flexible OLED) that is part of, or carried by the garment.

FIG. 17 shows a method 1700 of operation of a device, according to one illustrated implementation. The method 1700 can, for example, be executed by one or more processor-based devices, for instance an appearance configuration device such as described with reference to FIGS. 1A-1C. The method 1700 may be executed as part of the execution of method 1000 (FIG. 10).

At 1702, a processor-based device receives signals or senses information or input that is indicative of a condition, for example a present location of an item to be delivered, or a tool or supplies to be used in rendering services.

At 1704, a processor-based device or component thereof determines whether a present location of the item, tool or supplies is in or within a defined spatial relationship with respect to a defined geo-fenced location or geo-fenced area.

At 1706, a processor-based device or component thereof updates a visual appearance of the garment based at least in part on the determination whether a present location of the item, tool or supplies is in or within a defined spatial relationship with respect to a defined geo-fenced location or geo-fenced area. For example, a processor-based device or component thereof (drive circuitry) may send a set of drive signals to set a state of one or more addressable pixels (e.g., pixels of electronic paper, pixels of flexible OLED) that is part of, or carried by the garment.

FIG. 18 shows a method 1800 of operation of a device, according to one illustrated implementation. The method 1800 can, for example, be executed by one or more processor-based devices, for instance an appearance configuration device such as described with reference to FIGS. 1A-1C. The method 1800 may be executed as part of the execution of method 1000 (FIG. 10).

At 1802, a processor-based device receives signals or senses information or input that is indicative of a condition, for example an identity of a seller of an item to be delivered or provider of a service to be rendered.

At 1804, a processor-based device or component thereof updates a visual appearance of the garment based at least in part on the determination of the identity of a seller of an item to be delivered or of the provider of a service to be rendered. For example, a processor-based device or component thereof (drive circuitry) may send a set of drive signals to set a state of one or more addressable pixels (e.g., pixels of electronic paper, pixels of flexible OLED) that is part of, or carried by the garment.

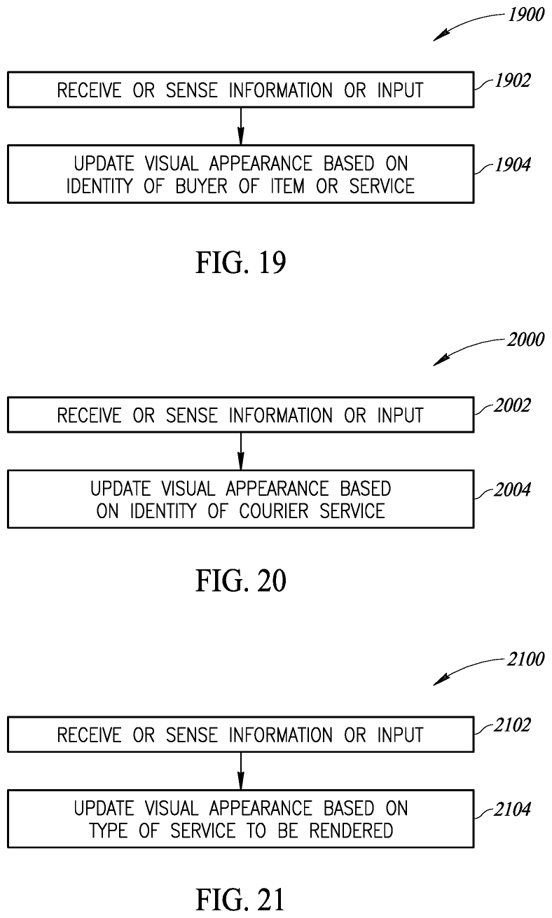

FIG. 19 shows a method 1900 of operation of a device, according to one illustrated implementation. The method 1900 can, for example, be executed by one or more processor-based devices, for instance an appearance configuration device such as described with reference to FIGS. 1A-1C. The method 1900 may be executed as part of the execution of method 1000 (FIG. 10).

At 1902, a processor-based device receives signals or senses information or input that is indicative of a condition, for example an identity of a buyer of an item to be delivered or of a service to be rendered.

At 1904, a processor-based device or component thereof updates a visual appearance of the garment based at least in part on the determination of the identity of a buyer of an item to be delivered or of a service to be rendered. For example, a processor-based device or component thereof (drive circuitry) may send a set of drive signals to set a state of one or more addressable pixels (e.g., pixels of electronic paper, pixels of flexible OLED) that is part of, or carried by the garment.

FIG. 20 shows a method 2000 of operation of a device, according to one illustrated implementation. The method 2000 can, for example, be executed by one or more processor-based devices, for instance an appearance configuration device such as described with reference to FIGS. 1A-1C. The method 2000 may be executed as part of the execution of method 1000 (FIG. 10).

At 2002, a processor-based device receives signals or senses information or input that is indicative of a condition, for example an identity of a courier service charged with delivery of an item or of a service to be rendered.

At 2004, a processor-based device or component thereof updates a visual appearance of the garment based at least in part on the determination of the identity of the courier service. For example, a processor-based device or component thereof (drive circuitry) may send a set of drive signals to set a state of one or more addressable pixels (e.g., pixels of electronic paper, pixels of flexible OLED) that is part of, or carried by the garment.

FIG. 21 shows a method 2100 of operation of a device, according to one illustrated implementation. The method 2100 can, for example, be executed by one or more processor-based devices, for instance an appearance configuration device such as described with reference to FIGS. 1A-1C. The method 2100 may be executed as part of the execution of method 1000 (FIG. 10).

At 2102, a processor-based device receives signals or senses information or input that is indicative of a condition, for example an identification of a type of service to be rendered.

At 2104, a processor-based device or component thereof updates a visual appearance of the garment based at least in part on the determination of the identity of the type of service to be rendered. For example, a processor-based device or component thereof (drive circuitry) may send a set of drive signals to set a state of one or more addressable pixels (e.g., pixels of electronic paper, pixels of flexible OLED) that is part of, or carried by the garment.

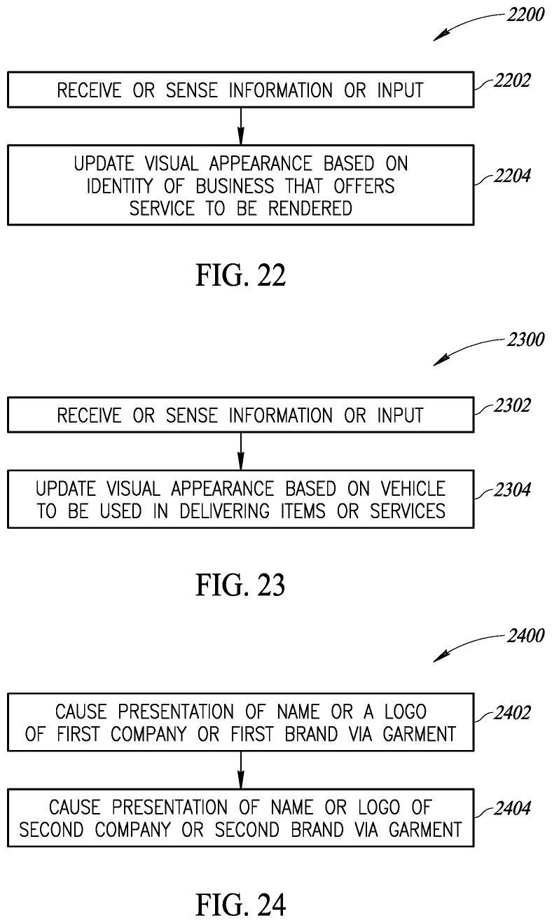

FIG. 22 shows a method 2200 of operation of a device, according to one illustrated implementation. The method 2200 can, for example, be executed by one or more processor-based devices, for instance an appearance configuration device such as described with reference to FIGS. 1A-1C. The method 2200 may be executed as part of the execution of method 1000 (FIG. 10).

At 2202, a processor-based device receives signals or senses information or input that is indicative of a condition, for example an identity of a business that offers service to be rendered.

At 2204, a processor-based device or component thereof updates a visual appearance of the garment based at least in part on the determination of the identity of the business that offers service to be rendered. For example, a processor-based device or component thereof (drive circuitry) may send a set of drive signals to set a state of one or more addressable pixels (e.g., pixels of electronic paper, pixels of flexible OLED) that is part of, or carried by the garment.

FIG. 23 shows a method 2300 of operation of a device, according to one illustrated implementation. The method 2300 can, for example, be executed by one or more processor-based devices, for instance an appearance configuration device such as described with reference to FIGS. 1A-1C. The method 2300 may be executed as part of the execution of method 1000 (FIG. 10).

At 2302, a processor-based device receives signals or senses information or input that is indicative of a condition, for example a unique identity (e.g., Vehicle Identification Number (VIN)) of a vehicle, a type of vehicle, and, or a make and model of a vehicle, to be used in the delivery of items or services to be rendered.

At 2304, a processor-based device or component thereof updates a visual appearance of the garment based at least in part on the determination of the identity of the vehicle to be used in the delivery of items or services to be rendered. For example, a processor-based device or component thereof (drive circuitry) may send a set of drive signals to set a state of one or more addressable pixels (e.g., pixels of electronic paper, pixels of flexible OLED) that is part of, or carried by the garment.

FIG. 24 shows a method 2400 of operation of a device, according to one illustrated implementation. The method 2400 can, for example, be executed by one or more processor-based devices, for instance an appearance configuration device such as described with reference to FIGS. 1A-1C. The method 2400 may be executed as part of the execution of method 1000 (FIG. 10).

At 2402, a processor-based device or component thereof sets a visual appearance of the garment to present a name or a logo of a first company or a first brand. For example, a processor-based device or component thereof (drive circuitry) may send a set of drive signals to set a state of one or more addressable pixels (e.g., pixels of electronic paper, pixels of flexible OLED) that is part of, or carried by the garment.

At 2404, a processor-based device or component thereof sets a visual appearance of the garment to present a name or a logo of a second company or a second brand. For example, a processor-based device or component thereof (drive circuitry) may send a set of drive signals to set a state of one or more addressable pixels (e.g., pixels of electronic paper, pixels of flexible OLED) that is part of, or carried by the garment.

Such can, for example, follow the presentation of the name or logo first color scheme associated with the first company or the first brand via the same garment. The name or logo associated with the second company or the second brand may be different in one or more respects from the name or logo associated with the first company or the first brand. The second company may be different from the first company. The second brand may be different from the first brand, and may be owned by a different company than the company that owns the first brand or may be owned by the same company that owns the first brand.

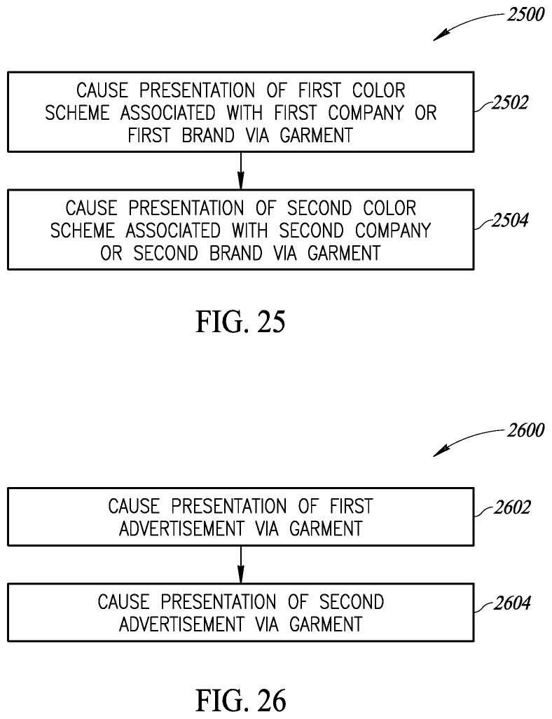

FIG. 25 shows a method 2500 of operation of a device, according to one illustrated implementation. The method 2500 can, for example, be executed by one or more processor-based devices, for instance an appearance configuration device such as described with reference to FIGS. 1A-1C. The method 2500 may be executed as part of the execution of method 1000 (FIG. 10).

At 2502, a processor-based device or component thereof sets a visual appearance of the garment to present a first color scheme associated with a first company or a first brand. For example, a processor-based device or component thereof (drive circuitry) may send a set of drive signals to set a state of one or more addressable pixels (e.g., pixels of electronic paper, pixels of flexible OLED) that is part of, or carried by the garment.

At 2504, a processor-based device or component thereof sets a visual appearance of the garment to present a second color scheme associated with a second company or a second brand. For example, a processor-based device or component thereof (drive circuitry) may send a set of drive signals to set a state of one or more addressable pixels (e.g., pixels of electronic paper, pixels of flexible OLED) that is part of, or carried by the garment.

Such can, for example, follow the presentation of the first color scheme associated with the first company or the first brand via the same garment. The second color scheme associated with the second company or the second brand may be different in one or more respects from the first color scheme associated with the first company or the first brand. The second company may be different from the first company. The second brand may be different from the first brand, and may be owned by a different company than the company that owns the first brand or may be owned by the same company that owns the first brand.

FIG. 26 shows a method 2600 of operation of a device, according to one illustrated implementation. The method 2600 can, for example, be executed by one or more processor-based devices, for instance an appearance configuration device such as described with reference to FIGS. 1A-1C. The method 2600 may be executed as part of the execution of method 1000 (FIG. 10).

At 2602, a processor-based device or component thereof sets a visual appearance of the garment to present a first advertisement. For example, a processor-based device or component thereof (drive circuitry) may send a set of drive signals to set a state of one or more addressable pixels (e.g., pixels of electronic paper, pixels of flexible OLED) that is part of, or carried by the garment.

At 2604, a processor-based device or component thereof sets a visual appearance of the garment to present a second advertisement. For example, a processor-based device or component thereof (drive circuitry) may send a set of drive signals to set a state of one or more addressable pixels (e.g., pixels of electronic paper, pixels of flexible OLED) that is part of, or carried by the garment.

Presentation of the second advertisement can, for example, follow the presentation of the first advertisement via the same garment. The first advertisement may, for example, be associated with a first company or a first brand. The second advertisement may, for example, be associated with a second company or a second brand. The second advertisement may be different in one or more respects from the first advertisement. The second company may be different from the first company. The second brand may be different from the first brand, and may be owned by a different company than the company that owns the first brand or may be owned by the same company that owns the first brand.

Various embodiments of the devices and/or processes via the use of block diagrams, schematics, and examples have been set forth herein. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information, can be stored on any computer readable medium for use by or in connection with any computer and/or processor related system or method. In the context of this document, a memory is a computer readable medium that is an electronic, magnetic, optical, or other another physical device or means that contains or stores a computer and/or processor program. Logic and/or the information can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic and/or information. In the context of this specification, a “computer readable medium” can be any means that can store, communicate, propagate, or transport the program associated with logic and/or information for use by or in connection with the instruction execution system, apparatus, and/or device. The computer readable medium can be, for example, but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

In addition, those skilled in the art will appreciate that certain mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. U.S. Pat. No. 9,292,889, issued Mar. 22, 2016, titled “Systems and Methods of Preparing Food Products”; U.S. patent application Ser. No. 62/311,787; U.S. patent application Ser. No. 15/040,866, filed Feb. 10, 2016, titled, “Systems and Methods of Preparing Food Products”; PCT Application No. PCT/US2014/042879, filed Jun. 18, 2014, titled, “Systems and Methods of Preparing Food Products”; U.S. patent application Ser. No. 15/465,228, filed Mar. 21, 2017, titled, “Container for Transport and Storage of Food Products”; U.S. Provisional Patent Application No. 62/311,787, filed Mar. 22, 2016, titled, “Container for Transport and Storage of Food Products”; PCT Application No. PCT/US2017/023408, filed Mar. 21, 2017, titled, “Container for Transport and Storage of Food Products”; U.S. patent application Ser. No. 15/481240, filed Apr. 6, 2017, titled, “On-Demand Robotic Food Assembly and Related Systems, Devices, and Methods”; U.S. Provisional Patent Application No. 62/320,282, filed Apr. 8, 2016, titled, “On-Demand Robotic Food Assembly and Related Systems, Devices, and Methods”; PCT Application No. PCT/US2017/026408, filed Apr. 6, 2017, titled, “On-Demand Robotic Food Assembly and Related Systems, Devices, and Methods”; U.S. Provisional Patent Application No. 62/394,063, filed Sep. 13, 2016, titled, “Cutter with Radially Disposed Blades”; U.S. Provisional Patent Application No. 62/532914, filed Jul. 14, 2017, titled, “SYSTEMS AND METHOD RELATED TO A FOOD-ITEM CUTTER AND ASSOCIATED COVER”; U.S. patent application Ser. No. 15/701099, filed Sep. 11, 2017, titled “SYSTEMS AND METHOD RELATED TO A FOOD-ITEM CUTTER AND ASSOCIATED COVER”; PCT Application No. PCT/US2017/050950, filed Sep. 11, 2017, titled, “SYSTEMS AND METHOD RELATED TO A FOOD-ITEM CUTTER AND ASSOCIATED COVER”; U.S. Provisional Patent Application No. 62/531,131, filed Jul. 11, 2017, titled, “Configurable Food Delivery Vehicle And Related Methods And Articles”; U.S. Provisional Patent Application No. 62/531,136, filed Jul. 11, 2017, titled, “Configurable Food Delivery Vehicle And Related Methods And Articles”; U.S. Provisional Patent Application No. 62/628,390, filed Feb. 9, 2018, titled, “Configurable Food Delivery Vehicle And Related Methods And Articles”; U.S. Provisional Patent Application No. 62/522,583, filed Jun. 20, 2017, titled, “Vehicle With Context Sensitive Information Presentation”; U.S. Provisional Patent Application No. 62/633,456, filed on Feb. 21, 2018, titled, “VEHICLE WITH CONTEXT SENSITIVE INFORMATION PRESENTATION”; U.S. Provisional Patent Application No. 62/633,457, filed Feb. 21, 2018, titled, “GARMENTS WITH CONFIGURABLE VISUAL APPEARANCES AND SYSTEMS, METHODS AND ARTICLES TO AUTOMATICALLY CONFIGURE SAME”; U.S. patent application Ser. No. 29/558,872; U.S. patent application Ser. No. 29/558,873; and U.S. patent application Ser. No. 29/558,874 are each incorporated herein by reference, in their entirety.

From the foregoing it will be appreciated that, although specific embodiments have been described herein for purposes of illustration, various modifications may be made without deviating from the spirit and scope of the teachings. Accordingly, the claims are not limited by the disclosed embodiments.

1-26. (canceled)

27. A method of operation in a garment that includes a fabric comprising at least a first plurality of addressable pixels and a control circuit communicatively coupled to control a respective optical appearance of the addressable pixels,
in response to a first signal, the control circuit causing the respective optical appearance of the addressable pixels to form at least a first identifying indicia at a first time; and
in response to a first signal, the control circuit causing the respective optical appearance of the addressable pixels to form at least a second identifying indicia at a second time, the second identifying indicia different from the first identifying indicia.

28. The method of claim 27 wherein causing the respective optical appearance of the addressable pixels to form at least a first identifying indicia at a first time includes causing the first identifying indicia to be displayed in a first area of the garment at the first time, and causing the respective optical appearance of the addressable pixels to form at least a second identifying indicia at a second time includes causing the second identifying indicia to be displayed in a second area of the garment at the second time, the second area different than the first area.

29. The method of claim 27 wherein causing the respective optical appearance of the addressable pixels to form at least a first identifying indicia at a first time includes causing the first identifying indicia to be displayed in a first area of the garment at the first time, and causing the respective optical appearance of the addressable pixels to form at least a second identifying indicia at a second time includes causing the second identifying indicia to be displayed in the first area of the garment at the second time.

30. The method of claim 27 wherein the garment includes at least one receiver communicatively coupled to the control circuit, further comprising:
providing signals by the at least one receiver to the control circuit in response to receipt of signals from an external source that is external to the garment.

31. The method of claim 30 wherein the at least one receiver is a radio, and further comprising:
receiving signals by the radio via at least one antenna communicatively coupled to the radio.

32. The method of claim 30 wherein the at least one receiver is a radio frequency identification (RFID) interrogator, and further comprising:
interrogating at least one RFID transponder by the RFID interrogator.

33. The method of claim 30 wherein the at least one receiver is a radio frequency identification (RFID) interrogator, and further comprising:
interrogating at least one RFID transponder by the RFID interrogator, the at least one RFID transponder physically associated with an item to be delivered.

34. The method of claim 27, further comprising:
receiving signals that indicate a present location of the garment, and wherein the causing the respective optical appearance of the addressable pixels to form at least a first identifying indicia at a first time and at least a second identifying indicia at a second time is in response to the signals that indicate the present location of the garment.

35. The method of claim 27, further comprising:
receiving signals that indicate a present location of the garment relative to a defined destination, and wherein the causing the respective optical appearance of the addressable pixels to form at least a first identifying indicia at a first time and at least a second identifying indicia at a second time is in response to the signals that indicate the present location of the garment relative to the defined destination.

36. The method of claim 27, further comprising:
receiving signals that indicate that the garment is a defined spatial relationship to a geo-fenced location, and wherein the causing the respective optical appearance of the addressable pixels to form at least a first identifying indicia at a first time and at least a second identifying indicia at a second time is in response to the signals that indicate the garment is in the defined spatial relationship to a geo-fenced location.

37. The method of claim 27, further comprising:
receiving signals that indicate that the garment is a defined spatial relationship to a geo-fenced destination location, and wherein the causing the respective optical appearance of the addressable pixels to form at least a first identifying indicia at a first time and at least a second identifying indicia at a second time is in response to the signals that indicate the garment is in the defined spatial relationship to the geo-fenced destination location.

38. The method of claim 27, further comprising:
receiving signals that indicate an item is in a defined proximity of the garment, and wherein the causing the respective optical appearance of the addressable pixels to form at least a first identifying indicia at a first time and at least a second identifying indicia at a second time is in response to the signals that indicate the item is in the defined proximity of the garment.

39. The method of claim 27, further comprising:
receiving signals that indicate a type of an item to be delivered, and wherein the causing the respective optical appearance of the addressable pixels to form at least a first identifying indicia at a first time and at least a second identifying indicia at a second time is in response to the signals that indicate the type of an item to be delivered.

40. The method of claim 27, further comprising:
receiving signals that indicate an item to be delivered is in a defined spatial relationship to a geo-fenced location, and wherein the causing the respective optical appearance of the addressable pixels to form at least a first identifying indicia at a first time and at least a second identifying indicia at a second time is in response to the signals that indicate the item to be delivered is in the defined spatial relationship to the geo-fenced location.

41. The method of claim 27, further comprising:
receiving signals that indicate a seller of an item to be delivered, and wherein the causing the respective optical appearance of the addressable pixels to form at least a first identifying indicia at a first time and at least a second identifying indicia at a second time is in response to the signals that indicate the seller of the item to be delivered.

42. The method of claim 27, further comprising:
receiving signals that indicate a courier service that will deliver an item, and wherein the causing the respective optical appearance of the addressable pixels to form at least a first identifying indicia at a first time and at least a second identifying indicia at a second time is in response to the signals that indicate the courier service that will deliver the item.

43. The method of claim 27, further comprising:
receiving signals that indicate a type of a service to be rendered, and wherein the causing the respective optical appearance of the addressable pixels to form at least a first identifying indicia at a first time and at least a second identifying indicia at a second time is in response to the signals that indicate the type of services to be rendered.

44. (canceled)

45. The method of claim 27, further comprising:
receiving signals that indicate a vehicle to be used in delivering at least one of items or services, and wherein the causing the respective optical appearance of the addressable pixels to form at least a first identifying indicia at a first time and at least a second identifying indicia at a second time is in response to the signals that indicate the vehicle to be used in delivering at least one of items or services.

46. The method of claim 27 wherein the garment is one of a shirt, a jacket, a vest, overalls, a hat, or a portion of a uniform, the fabric comprises electronic paper, and causing the respective optical appearance of the addressable pixels to form at least a first identifying indicia at a first time and at least a second identifying indicia at a second time includes selectively controlling the electronic paper.

47. The method of claim 27 wherein causing the respective optical appearance of the addressable pixels to form at least a first identifying indicia at a first time and at least a second identifying indicia at a second time includes causing presentation of at least one of a name or a logo of a first company or a first brand at the first time, and causing presentation of at least one of a name or a logo of a second company or a second brand at the second time, the second company or the second brand different than the first company or the first brand.

48. (canceled)

49. The method of claim 27 wherein causing the respective optical appearance of the addressable pixels to form at least a first identifying indicia at a first time and at least a second identifying indicia at a second time includes causing presentation of a first advertisement at the first time, and causing presentation of a second advertisement at the second time, the second advertisement different than the first advertisement.
